(19) United States
(12) Patent Application Publication
(10) Pub. No.: US 2025/0337733 A1
(43) Pub. Date: Oct. 30, 2025

(54) SYSTEMS AND METHODS FOR PERFORMING DIGITAL AUTHENTICATION

(71) Applicant: The PNC Financial Services Group, Inc., Pittsburgh, PA (US)

(72) Inventors: Lauren A WOODRING, Pittsburgh, PA (US); Jared SMITHERS, Pittsburgh, PA (US); Stacy MACKIN, Pittsburgh, PA (US); Aishwarya MANOJKUMAR, Pittsburgh, PA (US); Adam FINE, Pittsburgh, PA (US); Alex THROPP, Pittsburgh, PA (US); Zemin XU, Pittsburgh, PA (US); Shri DIKKAR, Pittsburgh, PA (US); Abdulaziz PATEL, Pittsburgh, PA (US); Sampath K PEECHU, Pittsburgh, PA (US); Luke Joseph OFFERMAN, Pittsburgh, PA (US); Garrick Lance FRIEDLANDER, Pittsburgh, PA (US); Praneeth KARANAM, Pittsburgh, PA (US); Thomas Lucas MCCARTHY, Pittsburgh, PA (US); Mumen RAMADAN, Pittsburgh, PA (US); Femina AZMI, Pittsburgh, PA (US); Praveen Kumar CHANDRASEKARAN, Pittsburgh, PA (US); Ashok Kumar CHEJARLA, Pittsburgh, PA (US); Sambasivarao YARLAGADDA, Pittsburgh, PA (US); Venkata V VURA, Pittsburgh, PA (US)

(73) Assignee: The PNC Financial Services Group, Inc., Pittsburgh, PA (US)

(21) Appl. No.: 19/096,735

(22) Filed: Apr. 1, 2025

Related U.S. Application Data
(63) Continuation of application No. 19/067,696, filed on Feb. 28, 2025.
(60) Provisional application No. 63/640,840, filed on Apr. 30, 2024.

(51) Int. Cl. H04L 9/40

(52) U.S. Cl. CPC H04L 63/083

(57) ABSTRACT

A system for digital authentication may include an authentication server. The system may be configured to receive a login request from a user device associated with a user. The login request may include a user identity data element and a login request data element. The system may be configured to retrieve, based on the login request, a supplemental data element associated with the user from a recording server and determine whether the login request data element matches the supplemental data element and in response to a determination that the login request data element matches the supplemental data element: perform an authentication on the user device; configure the user device as authenticated in response to the authentication; and in response to configure the user device as authenticated: configure a first login mode as an authenticated status; and configure a second login mode as the authenticated status.

### CROSS-REFERENCE TO RELATED APPLICATION

This application claims the benefit of priority of U.S. Provisional Patent Application No. 63/640,840, filed on Apr. 30, 2024, the entire contents of which are incorporated herein by reference.

### TECHNICAL FIELD

The present disclosure relates to the field of information security technology. More specifically, the present disclosure relates information security technology using digital authentication.

### BACKGROUND

Service providers, such as banks, often require users to authenticate their digital identity using multiple credentials for different accounts across various access points associated with distinct services. While the users can mitigate the risks of attacks by creating unique, complex passwords for each account, managing multiple passwords can be challenging and may lead to reluctance. Although enabling additional security features can further reduce the risks of attacks, requiring these features for each login can be tedious and time-consuming. Therefore, an authentication process that allows users to verify their digital identity with a single set of unique, complex credentials, and security features, granting secure access to all login access points associated with a service provider is needed. Additionally, a login process that does not rely solely on complex passwords is also needed.

Similarly, large systems, such as those used by banks, often have multiple access points with varying login experiences. This inconsistency can frustrate users due to unpredictable differences among similar access points. Therefore, a unified authentication functionality that enables developers to create a consistent login experience across all the access points associated with each large system is needed.

### SUMMARY

In view of the foregoing, embodiments of the present disclosure address disadvantages of existing large systems by providing novel systems and methods for performing digital authentication.

Embodiments of the present disclosure provide a method for performing digital authentication. The method may include providing a first login access point associated with a service provider for displaying on a first visual user interface, the first login access point including: a first login credential request access point, and a first login mode, the first login mode indicating an unauthenticated status; receiving a login request from a user device associated with a user, the login request including: a user identity data element, and a login request data element associated with the first login credential request access point; retrieving, based on the login request, a supplemental data element from a database through a recording server; determining whether the login request data element matches the supplemental data element; in response to a determination that the login request data element matches the supplemental data element: performing a two-factor authentication on the user device when receiving a two-factor authentication request from the user device; configuring the first login mode as an authenticated status in response to the two-factor authentication; providing a second login access point associated with the service provider for display on a second visual user interface, the second login access point including: a second login credential request access point, and a second login mode, the second login mode indicating the unauthenticated status; and configuring the second login mode as the authenticated status in response to the first login mode being configured as the authenticated status.

The embodiments of the present disclosure also provide a system for performing digital authentication. The system may include an authentication server in communication with a user device associated with a user, the authentication server configured to: receive a login request from the user device, the login request including a user identity data element and a login request data element; retrieve, based on the login request, a supplemental data element associated with the user from a recording server; determine whether the login request data element matches the supplemental data element; and in response to a determination that the login request data element matches the supplemental data element: perform a two-factor authentication on the user device when receiving a two-factor authentication request from the user device; configure the user device as authenticated in response to the two-factor authentication; and in response to configuring the user device as authenticated: configure a first login mode as an authenticated status; and configure a second login mode as the authenticated status.

The embodiments of the present disclosure also provide a method for performing digital authentication. The method may include providing an authentication access point for displaying on a visual user interface, the authentication access point including an authentication mode indicating an unauthenticated status; receiving an authentication request from a user device associated with a user, the authentication request including an authentication request input; and transmitting the authentication request to an authentication server, the authentication server configured to process the authentication request input using an authentication integration framework to bypass a legacy authentication process, the authentication server configured to: generate an authentication parameter based on the authentication request input; retrieve, based on the authentication request, a supplemental data element from a database through a recording server; determine whether the authentication parameter matches the supplemental data element; and in response to a determination that the authentication parameter matches the supplemental data element: configure the authentication mode as an authenticated status; and transmit a notification for displaying the authentication mode on the visual user interface.

The embodiments of the present disclosure also provide a system for performing digital authentication. The system may include an authentication server in communication with a user device associated with a user, the authentication server configured to: receive an authentication request from the user device, the authentication request including an authentication request input; and process the authentication request input using an authentication integration framework to bypass a legacy authentication process, the authentication integration framework configured to: generate an authentication parameter based on the authentication request input; retrieve a supplemental data element from a recording server; determine whether the authentication parameter matches the supplemental data element; and in response to a determination that the authentication parameter matches the supplemental data element: configure an authentication mode associated with the authentication request as an authenticated status; and transmit a notification to the user device, the notification including the authentication mode.

The embodiments of the present disclosure also provide a method for performing digital authentication. The method may include receiving a first login request for a first cloud service from a first user device associated with a user, wherein the first login request includes a first digital identity of the user, the first digital identity including at least one of a username or a password; determining whether the first digital identity matches a second digital identity of the user stored in a database; in response to a determination that the first digital identity matches the second digital identity, transmitting an authentication request to an authentication server, for authenticating the first user device based on the username or the password; receiving a token associated with the first cloud service from the authentication server; redirecting the first user device to a service access point, for accessing the first cloud service; receiving a second login request for a second cloud service from a second user device associated with the user, wherein the second login request includes the token shared by the first user device on a cloud server; determining that the second login request is authenticated according to the token; and instructing the second user device to access the service access point, for accessing the second cloud service.

The embodiments of the present disclosure also provide a system for performing digital authentication. The system may include an identity checking server in communication with a first user device associated with a user, the identity checking server configured to: receive a first login request for a first cloud service from the first user device, wherein the first login request includes a first digital identity of the user, the first digital identity including at least one of a username or a password; determine whether the first digital identity matches a second digital identity of the user stored in a database; in response to a determination that the first digital identity matches the second digital identity, transmit an authentication request to an authentication server, for authenticating the first user device based on the username or the password; receive a token associated with the first cloud service from the authentication server; redirect the first user device to a service access point, for accessing the first cloud service; receive a second login request for a second cloud service from a second user device associated with the user, wherein the second login request includes the token shared by the first user device on a cloud server; determine that the second login request is authenticated according to the token; and instruct the second user device to access the service access point, for accessing the second cloud service.

The embodiments of the present disclosure also provide a method for performing digital authentication. The method may include receiving a first login request for a first cloud service through a first web-based user interface configured for display on a user device, the first web-based user interface being generated according to a first one of a plurality of web-based frameworks having a first framework type; transmitting a first authentication option to an authentication server for authenticating the first login request; receiving first information from the authentication server, the first information including that the first login request is authenticated; transmitting for display on the user device a first landing interface for the first cloud service; receiving a second login request for a second cloud service through a second web-based user interface configured for display on the user device, the second web-based user interface being generated according to a second one of the plurality of web-based frameworks having a second framework type, wherein the second framework type is different from the first framework type; transmitting a second authentication option to the authentication server for authenticating the second login request; receiving second information from the authentication server, the second information including that the second login request is authenticated; and transmitting for display on the user device a second landing interface for the second cloud service.

The embodiments of the present disclosure also provide a system for performing digital authentication. The system may include a memory storing a set of instructions; and a processor configured to execute the stored instructions to perform operations including: receive a first login request for a first cloud service through a first web-based user interface configured for display on a user device, the first web-based user interface being generated according to a first one of a plurality of web-based frameworks having a first framework type; transmit a first authentication option to an authentication server for authenticating the first login request; receive first information from the authentication server, the first information including that the first login request is authenticated; transmit for display on the user device a first landing interface for the first cloud service; receive a second login request for a second cloud service through a second web-based user interface configured for display on a user device, the second web-based user interface being generated according to a second one of the plurality of web-based frameworks having a second framework type, wherein the second framework type is different from the first framework type; transmit a second authentication option to the authentication server for authenticating the second login request; receive second information from the authentication server, the second information including that the second login request is authenticated; and transmit for display on the user device display a second landing interface for the second cloud service.

The embodiments of the present disclosure also provide a method for performing digital authentication. The method may include receiving a user input for logging into a cloud service from a user device through a login access point on a web-based user interface configured for display on the user device; sending a request to update the web-based user interface from the login access point to an authentication access point; initiating an authentication integration framework to transmit an authentication request to an authentication server for authenticating the user device; receiving, through the authentication integration framework, a token associated with the cloud service from the authentication server; storing the token as associated with a session of a browser engine through the web-based user interface; redirecting the user device from the authentication access point to a landing interface for the cloud service; and transmitting for display on the user device the landing interface for the cloud service.

The embodiments of the present disclosure also provide a system for performing digital authentication. The system may include a memory storing a set of instructions; and a processor configured to execute the stored instructions to perform operations including: receive a user input for logging into a cloud service from a user device through a login access point on a web-based user interface configured for display on the user device; send a request to update the web-based user interface from the login access point to an authentication access point; initiate an authentication integration framework to transmit an authentication request to an authentication server for authenticating the user device; receive, through the authentication integration framework, a token associated with the cloud service from the authentication server; store the token as associated with a session of a browser engine through the web-based user interface; redirect the user device from the authentication access point to a landing interface for the cloud service; and transmit for display on the user device the landing interface for the cloud service.

The embodiments of the present disclosure also provide a method for performing digital authentication. The method may include receiving a registration request for registering a biometric authenticator associated with a user on a user device through a visual user interface; providing a user identity and the biometric authenticator associated with the user to an authentication integration framework for starting a registration of the biometric authenticator associated with the user on the user device; in response to successfully registering the biometric authenticator associated with the user on the user device, receiving a public key and a public key identity from the authentication integration framework; transmitting the public key and the public key identity to an authentication server through a service server; receiving a complete message from the authentication server through the service server, the complete message indicating that the registration is completed; and displaying that the registration is completed through the visual user interface.

The embodiments of the present disclosure also provide a system for performing digital authentication. The system may include a memory storing a set of instructions; and a processor configured to execute the stored instructions to perform operations including: receive a registration request for registering a biometric authenticator associated with a user on a user device through a visual user interface; provide a user identity and the biometric authenticator associated with the user to an authentication integration framework for starting a registration of the biometric authenticator associated with the user on the user device; in response to successfully registering the biometric authenticator associated with the user on the user device, receive a public key and a public key identity from the authentication integration framework; transmit the public key and the public key identity to an authentication server through a service server; receive a complete message from the authentication server through the service server, the complete message indicating that the registration is completed; and display that the registration is completed through the visual user interface.

The embodiments of the present disclosure also provide a method for performing digital authentication. The method may include receiving an authentication request through a visual user interface, the authentication request including a password credential associated with a user device; transmitting the password credential to a service server, for initiating an authentication of the user device; receiving an authentication response from the service server, the authentication response including a token validated by the service server; and transmitting an authentication result to an authentication integration framework, the authentication result including a user identity, a user device identity, or the validated token.

The embodiments of the present disclosure also provide a system for performing digital authentication. The system may include a memory storing a set of instructions; and a processor configured to execute the stored instructions to perform operations including: receive an authentication request through a visual user interface, the authentication request including a password credential associated with a user device; transmit the password credential to a service server, for initiating authenticating the user device; receive an authentication response from the service server, the authentication response including a token validated by the service server; and transmit an authentication result to an authentication integration framework, the authentication result including a user identity, a user device identity, or the validated token.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1 illustrates an exemplary scenario of different login access points requiring different login credentials, according to some embodiments of the present disclosure.

FIG. 2 illustrates an exemplary scenario of different login experiences, according to some embodiments of the present disclosure.

FIG. 3 illustrates an exemplary digital authentication system, according to some embodiments of the present disclosure.

FIG. 4 illustrates a flow chart of an exemplary process for digital authentication, which may be performed by the exemplary digital authentication system in FIG. 3, according to some embodiments of the present disclosure.

FIG. 5 illustrates an exemplary digital authentication system, according to some embodiments of the present disclosure.

FIG. 6 illustrates a flow chart of an exemplary process for digital authentication, which may be performed by the exemplary digital authentication system in FIG. 5, according to some embodiments of the present disclosure.

FIG. 7 illustrates a visual user interface of the exemplary user device of FIG. 3 for digital authentication, according to some embodiments of the present disclosure.

FIG. 8 illustrates a visual user interface of the exemplary user device of FIG. 5 for digital authentication, according to some embodiments of the present disclosure.

FIG. 9 illustrates an exemplary digital authentication system, according to some embodiments of the present disclosure.

FIG. 10 illustrates a flow chart of an exemplary process for digital authentication, which may be performed by the exemplary digital authentication system in FIG. 9, according to some embodiments of the present disclosure.

FIG. 11 illustrates an exemplary digital authentication system, according to some embodiments of the present disclosure.

FIG. 12 illustrates a flow chart of an exemplary process for digital authentication, which may be performed by the exemplary digital authentication system in FIG. 11, according to some embodiments of the present disclosure.

FIG. 13 illustrates an exemplary implementation of the exemplary process in FIG. 12 for digital authentication, according to some embodiments of the present disclosure.

FIG. 14 illustrates a flow chart of an exemplary process for digital authentication, which may be performed by the exemplary digital authentication system in FIG. 11, according to some embodiments of the present disclosure.

FIG. 15 illustrates an exemplary implementation of the exemplary process in FIG. 14 for digital authentication, according to some embodiments of the present disclosure.

FIG. 16 illustrates a deployment for the exemplary digital authentication system in FIG. 11 and the exemplary implementation 1500 in FIG. 15 for digital authentication, according to some embodiments of the present disclosure.

FIG. 17 illustrates an exemplary biometrics registration flow diagram for digital authentication, which may be performed by the exemplary digital authentication system in FIG. 11, according to some embodiments of the present disclosure.

FIG. 18 illustrates an exemplary biometrics authentication flow diagram for digital authentication, which may be performed by the exemplary digital authentication system in FIG. 11, according to some embodiments of the present disclosure.

FIG. 19 illustrates an exemplary password authentication flow diagram for digital authentication, which may be performed by the exemplary digital authentication system in FIG. 11, according to some embodiments of the present disclosure.

FIG. 20 illustrates a block diagram of an exemplary computing device in the exemplary digital authentication systems in FIG. 3, 5, 9, or 11, according to some embodiments of the present disclosure.

### DETAILED DESCRIPTION

Reference will now be made in detail to exemplary embodiments, discussed with reference to the accompanying drawings. Unless otherwise stated, technical and/or scientific terms have the meaning commonly understood by one of ordinary skill in the art. It is to be understood that other embodiments may be implemented and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed, without departing from the envisioned embodiments. Thus, the materials, methods, and examples are illustrative only and are not intended to be necessarily limited.

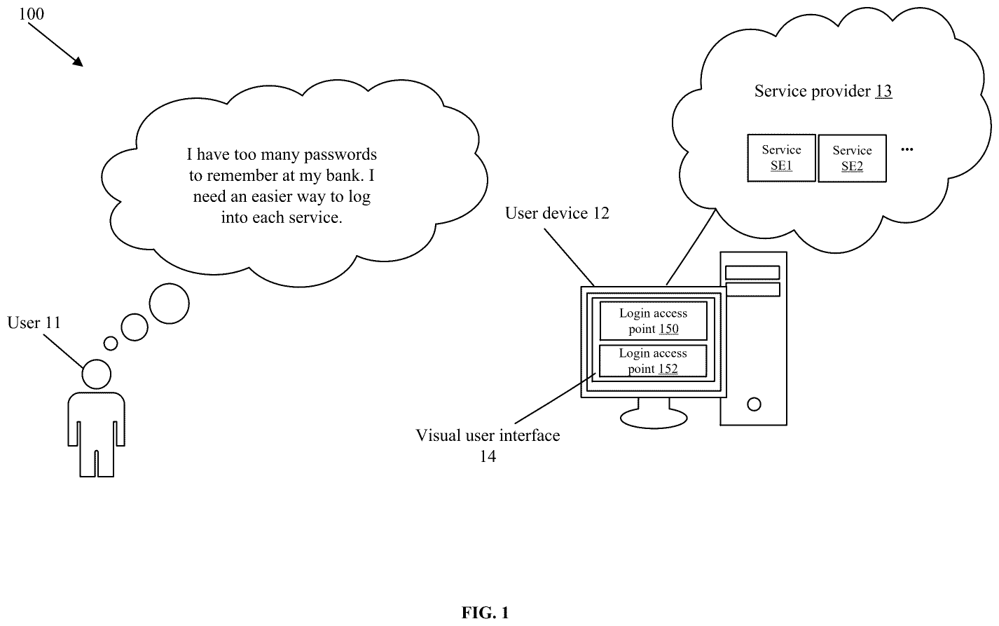

FIG. 1 illustrates an exemplary scenario 100 of different login access points requiring different login credentials, according to some embodiments of the present disclosure. As shown in FIG. 1, a user 11 may access, via a user device 12 displaying a visual user interface 14, a plurality of services, such as services SE1 and SE2, provided by a service provider 13 on the Internet. The user device 12 may include a television, a tablet, a desktop computer, a mobile phone, a laptop computer, or any combination thereof. Each of the services SE1 and SE2 may require the user 11 to register an account and set up a password. As a result, the user 11 may have many accounts and passwords to remember. In some embodiments, the service provider 13 may include a financial institution such as a bank. In some embodiments, the service provider 13 may be a parent company that owns and operates one or more subsidiaries to provide the services SE1 and SE2. The service provider 13 may be configured to create different login access points 150 and 152 for services SE1 and SE2. The offered services SE1 and SE2 may include personal banking, commercial banking, investment banking, mortgage servicing, auto loan servicing, social media, online purchases, email, document sharing, a professional association, insurance, medical services, online gambling, online services, physical services, hospitality services, utilities, subscription services, or other services requiring or being improved by offering login credentials. The service provider 13 may require different login information, which may include but is not limited to, different passwords, for each service. The use of the different login information may include different passwords, and may cause the user 11 to struggle to remember too many passwords and seek an easier way to log into each service. In some embodiments, the user 11 may use the user device 12 to input the login information for each of the services SE1 and SE2.

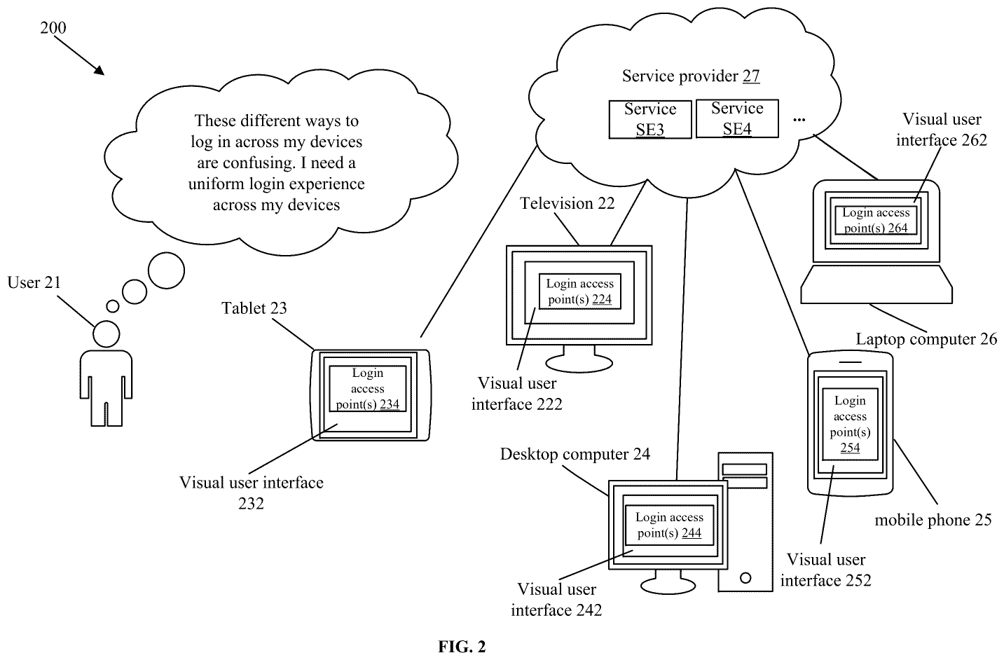

FIG. 2 illustrates an exemplary scenario 200 of different login experiences, according to some embodiments of the present disclosure. As shown in FIG. 2, a user 21 may access services SE3 and SE4 provided by a service provider 27 by a television 22, a tablet 23, a desktop computer 24, a mobile phone 25, a laptop computer 26, or any combination thereof, via login access point(s) 224, 234, 244, 254, or 264 displayed on visual user interfaces 222, 232, 242, 252, or 262, respectively. The user 21 may be confused by having so many ways to log into one or more services SE3 and SE4 across these devices. The user 21 may need a uniform login experience across these devices, for accessing services SE3 and SE4 associated with the service provider 27.

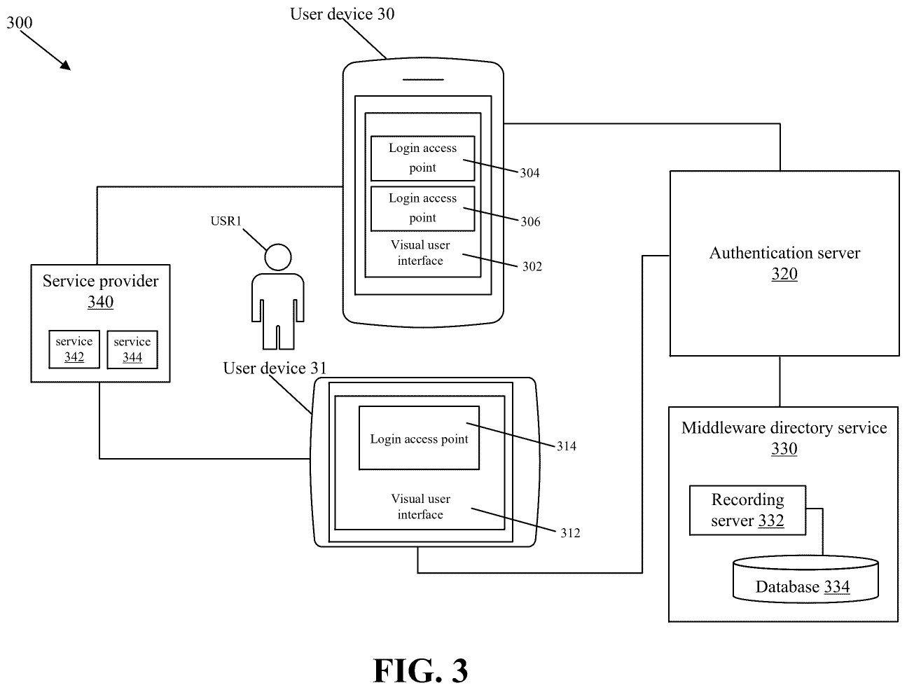

FIG. 3 illustrates an exemplary digital authentication system 300, according to some embodiments of the present disclosure. As shown in FIG. 3, the digital authentication system 300 may include user devices 30 and 31 associated with a user USR1, an authentication server 320, a middleware directory service 330, and a service provider 340 providing services 342 and 344. The user devices 30 and 31 may include visual user interface drivers (not shown). The visual user interface drivers may be configured to generate visual user interfaces 302 and 312 displayed on the user devices 30 and 31, respectively. In some embodiments, the user devices 30 and 31 may include a television, a tablet, a desktop computer, a laptop computer, a mobile phone, a wearable or portable electronic device, any device capable of computing and connecting to a network, or any combination thereof. The visual user interface 302 may be configured to display login access points 304 and 306 associated with the service provider 340. The visual user interfaces 312 may be configured to display a login access point 314 associated with the service provider 340. The visual user interfaces 302 and 312 and/or the login access points 304, 306, and 314 may include user interface control elements configured to associate the visual user interfaces 302 and 312 and/or the login access points 304, 306, and 314 to the service provider 340. For example, the user interface control elements may be configured to differentiate the visual user interfaces 302 or 312 and/or the login access points 304, 306, and 314. The visual user interfaces 302 and 312 and/or the login access points 304, 306, and 314 may include security features configured to protect from copying the design features of the visual user interfaces 302 and 312 and/or the login access points 304, 306, and 314. The visual user interfaces 302 may bear aesthetic similarities to the visual user interface 312.

The authentication server 320 may be configured to communicate with the user device 30 through the login access points 304 or 306. The authentication server 320 may be configured to communicate with the user device 31 through the login access point 314. These communications may be performed through an electronic communication channel. The electronic communication channel may be, for example, a wired or unwired communication channel and may be configured to protect data transmitted through the electronic communication channel using a security protocol (e.g., encryption).

The middleware directory service 330 may include a recording server 332 and a database 334, for recording, organizing, and/or managing data and/or information (e.g., data and/or information about the user USR1, the user devices 30 and 31, and/or the services 342 and 344) associated with the digital authentication system 300. The recording server 332 may include a lightweight directory access protocol (LDAP) directory. The database 334 may include a unified directory (e.g., Oracle Unified Directory (OUD)) configured to provide scalable storage services. The recording server 332 may be configured to be hosted on the database 334. The communication between the recording server 332 and the authentication server 320, or between the recording server 332 and the database 334, may be performed on an electronic communication channel similar to the electronic communication channel described above with respect to the user device 30 and the authentication server 320. The authentication server 320 may be configured to query the recording server 332 to verify login or authentication information associated with the user USR1. For example, the recording server 332 may be configured to receive data retrieving or searching requests (e.g., queries) from the authentication server 320. The recording server 332 may be configured to transmit retrieved or searched data associated with the user USR1 to the authentication server 320, for the authentication server 320 to verify the login information associated with the user USR1.

The service provider 340 may be configured to provide different services, such as services 342 and 344. The service provider 340 may be configured to create different login access points (e.g., login access points 304, 306, and 314) associated with the different services (e.g., services 342 and 344). The service provider 340 may include a financial institution (e.g., a bank). The services 342 and 344 may include personal banking, commercial banking, investment banking, mortgage servicing, loan servicing, payment processing, social media, online purchases, email, document sharing, professional association, insurance, medical services, online gambling, online services, physical services, hospitality services, utilities, subscription services, or any other services that requires offering login credentials to access. The services 342 and 344 may enable the user USR1 to apply for setting up a user account and/or access via associated web-based application(s) (APP(s)).

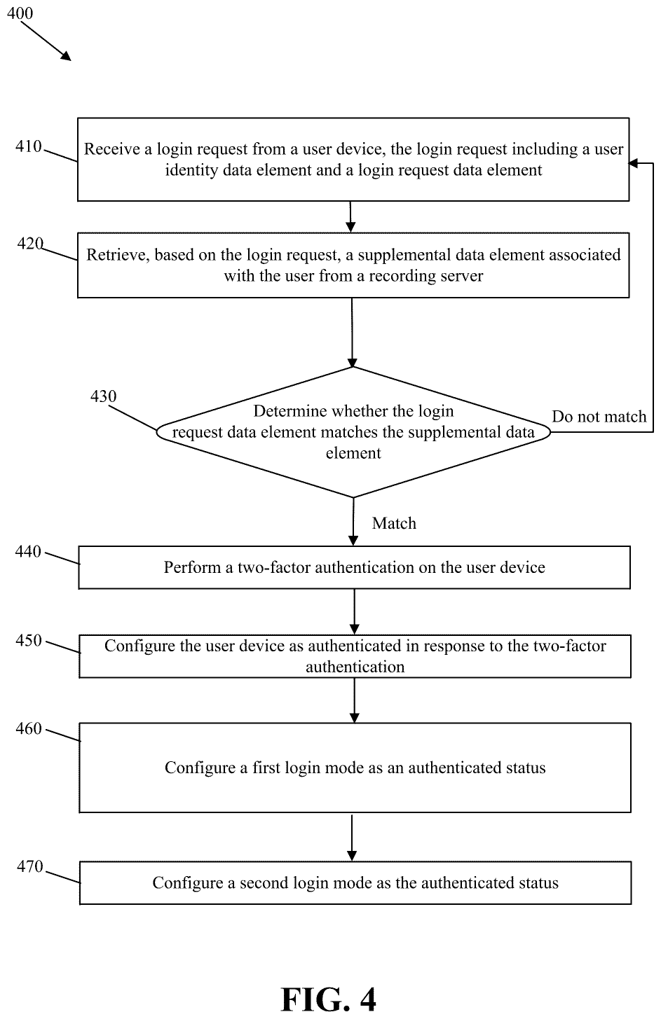

FIG. 4 illustrates a flow chart of an exemplary process 400 for digital authentication, which may be performed by exemplary digital authentication system 300 in FIG. 3, according to some embodiments of the present disclosure. At step 410, process 400 may include receiving a login request from a user device, the login request including a user identity data element and a login request data element. At step 420, process 400 may include retrieving, based on the login request, a supplemental data element associated with the user from a recording server. At step 430, process 400 may include determining whether the login request data element matches the supplemental data element. At step 440, process 400 may include, in response to a determination that the login request data element matches the supplemental data element, performing a two-factor authentication on the user device. At step 450, process 400 may include configuring the user device as authenticated in response to the two-factor authentication. At step 460, process 400 may include configuring a first login mode as an authenticated status. At step 470, process 400 may include configuring a second login mode as the authenticated status.

For example, the digital authentication system 300 (as shown in FIG. 3) may be configured to receive, from the user device 30 (as shown in FIG. 3) through the login access point 304 or 306 displayed on the visual user interface 302 (as shown in FIG. 3) or through the login access point 314 displayed on the visual user interface 312 (as shown in FIG. 3), a setup request for setting up a user account before the user USR1 (as shown in FIG. 3) first accesses or logs into the service 342 or 344 (as shown in FIG. 3). The digital authentication system 300 (as shown in FIG. 3) may be configured to display a form requesting the user USR1 (as shown in FIG. 3) to fill out or register personal information. The personal information may include username, email, phone number, and/or any other contact details. The user USR1 (as shown in FIG. 3) may fill out the form by inputting and entering the required personal information. The digital authentication system 300 (as shown in FIG. 3) may be configured to prompt the user USR1 (as shown in FIG. 3) to create a username and password. The user USR1 (as shown in FIG. 3) may create the username and password meeting security requirements specified by the digital authentication system 300 (as shown in FIG. 3) or the service provider 340 (as shown in FIG. 3). The digital authentication system 300 (as shown in FIG. 3) may be configured to transmit a verification code to the email or phone number registered by the user USR1 (as shown in FIG. 3). The user USR1 (as shown in FIG. 3) may input the received verification code to confirm digital identity of the user USR1 (as shown in FIG. 3). The digital authentication system 300 (as shown in FIG. 3) may be configured to verify the verification code and confirm the digital identity of the user USR1 (as shown in FIG. 3). The digital authentication system 300 (as shown in FIG. 3) may be configured to display terms and conditions of the service provider 340 (as shown in FIG. 3) for the user USR1 (as shown in FIG. 3) to review. The user USR1 (as shown in FIG. 3) may read and agree to the terms and conditions. The digital authentication system 300 (as shown in FIG. 3) may be configured to prompt the user USR1 (as shown in FIG. 3) with a confirmation message through the login access point 304, or 306, to complete setting up the user account.

After the user account is set up, the digital authentication system 300 may be configured to provide the login access point 304 (as shown in FIG. 3) associated with the service provider 340 (as shown in FIG. 3). For example, the user device 30 (as shown in FIG. 3) may be configured to display the login access point 304 (as shown in FIG. 3) associated with the service provider 340 (as shown in FIG. 3) on the visual user interface 302 (as shown in FIG. 3). The login access point 304 (as shown in FIG. 3) may include a first login credential request access point (not shown) and a first login mode (not shown). The login access point 304 (as shown in FIG. 3) may include a user input field associated with the first login credential request access point. The user input field may be configured to receive a user input. The user input may include at least one of a username, a password, a personal identification number (PIN), an account number, an email address, a sent one-time passcode (OTP), or an answer to a security question. The first login mode may be configured by default to indicate an unauthenticated status. In some embodiments, the login access point 304 (as shown in FIG. 3) may be a trusted login access point. In such embodiments, the login access point 304 (as shown in FIG. 3) may be trusted by other login access points 306 and 314 (as shown in FIG. 3) associated with the same service provider 340 (as shown in FIG. 3). For example, when the first login mode of the login access point 304 (as shown in FIG. 3) is configured as the authenticated status, the other login access points 306 and 314 (as shown in FIG. 3) may not require all authentication steps as required by the login access point 304 (as shown in FIG. 3). The authentication steps requested by the login access point 304 may include authenticating the digital identity of the user USR1 (as shown in FIG. 3) (e.g., login credentials, such as username and password, which the user USR1 (as shown in FIG. 3) knows), and authenticating additional factor(s) that the user USR1 (as shown in FIG. 3) has or is. The additional factor(s) that the user USR1 (as shown in FIG. 3) has may include a secret token or a smart card number. The additional factor(s) that the user USR1 (as shown in FIG. 3) is may include a biometric identifier of the user USR1 (as shown in FIG. 3) or a location of the user USR1 (as shown in FIG. 3). In some embodiments, the other login access points 306 and 314 may be configured to not repeatedly require part of the authentication steps, such as authenticating the digital identity of the user USR1 (as shown in FIG. 3), and may be configured to require part of the authentication steps, such as authenticating the additional factor(s) of the user USR1 (as shown in FIG. 3).

The digital authentication system 300 may be further configured to provide the login access points 306 or 314 (as shown in FIG. 3) associated with the service provider 340 (as shown in FIG. 3). For example, the user device 30 (as shown in FIG. 3) may be configured to display the login access point 306 (as shown in FIG. 3) on the visual user interface 302 (as shown in FIG. 3). For another example, the user device 31 (as shown in FIG. 3) may be configured to display the login access point 314 (as shown in FIG. 3) on the visual user interface 312 (as shown in FIG. 3). The login access point 306 or 314 (as shown in FIG. 3) may include a second login credential request access point (not shown) and a second login mode (not shown). The login access point 306 or 314 (as shown in FIG. 3) may include a user input field associated with the second login credential request access point. The user input field may be configured to receive a user input, which may include at least one of a username, a password, a PIN, an account number, an email address, or an answer to a security question. The second login mode may be configured by default to indicate an unauthenticated status.

In some embodiments, the login access point 304 (as shown in FIG. 3) and the login access point 306 or 314 (as shown in FIG. 3) may be associated with different services (e.g., services 342 and 344, as shown in FIG. 3). In such embodiments, the login access point 306 or 314 (as shown in FIG. 3) may be associated with a service (e.g., service 342 as shown in FIG. 3) different from that (i.e., service 344 as shown in FIG. 3) of the login access point 304 (as shown in FIG. 3), or may be (e.g., historically) associated with a corporate entity different from that of the login access point 304 (as shown in FIG. 3).

In some embodiments, the login access point 306 or 314 (as shown in FIG. 3) may be an untrusted access point. In some embodiments, the login access point 306 or 314 (as shown in FIG. 3) may be a trusted login access point different from the login access point 304 (as shown in FIG. 3). In some embodiments, the login access point 304 (as shown in FIG. 3) may be determined as a trusted login access point based on an attribute associated with the login access point 306 or 314 (as shown in FIG. 3). In some embodiments, the login access point 306 or 314 (as shown in FIG. 3) may be determined as a trusted or untrusted login access point based on an attribute associated with either the login access point 304 (as shown in FIG. 3) or any other login access point(s) (not shown). In some embodiments, the login access point 304 (as shown in FIG. 3) or the login access point 306 or 314 (as shown in FIG. 3) may be determined as a trusted or untrusted login access point based on an attribute associated with the service provider 340 (as shown in FIG. 3). The attribute may include a service type, a device type, a login history, or an access point credential (e.g., security credential or key). In some embodiments, the service provider 340 (as shown in FIG. 3) may be configured to determine which of the login access points 304, 306, or 314 (as shown in FIG. 3) is trusted and which of the login access points 304, 306, or 314 (as shown in FIG. 3) is untrusted. The determination may be made based on a login requirement associated with the login access point 304, 306, or 314 (as shown in FIG. 3). The login requirement may include a security requirement specified by the digital authentication system 300 (as shown in FIG. 3) or the service provider 340 (as shown in FIG. 3). In some embodiments, the login access point 306 or 314 (as shown in FIG. 3) may be configured to provide functionality different from functionality provided by the login access point 304 (as shown in FIG. 3). For example, the login access point 304 (as shown in FIG. 3) may be provided for accessing basic or general services, which may include email or calendar applications. Accessing these services may require authenticating the digital identity of the user USR1 (as shown in FIG. 3) and the use of basic security protocols (e.g., authenticating a password of the user USR1 (as shown in FIG. 3) through the user device 30 (as shown in FIG. 3)). The login access point 306 or 314 (as shown in FIG. 3) may be provided for accessing sensitive or confidential services, which may include financial applications (e.g., deposit, loan, or investment). Accessing these services may require authenticating the digital identity of the user USR1 (as shown in FIG. 3) and the use of enhanced security protocols (e.g., authenticating the additional factor(s) of the user USR1 (as shown in FIG. 3) through the user devices 30 or 31 (as shown in FIG. 3)) as described above.

In some embodiments, the login access point 304 (as shown in FIG. 3) and the login access point 306 or 314 (as shown in FIG. 3) may be linked using applications or software based on their association with the service provider 340 (as shown in FIG. 3). In some embodiments, the user devices 30 or 31 (as shown in FIG. 3) may be navigated to the login access point 306 or 314 (as shown in FIG. 3), before the second login mode of the login access point 306 or 314 (as shown in FIG. 3) is configured as the authenticated status. In some embodiments, the user device 30 (as shown in FIG. 3) may be configured to access functionality associated with the login access point 306 or 314 (as shown in FIG. 3) through the login access point 304 (as shown in FIG. 3).

The user USR1 (as shown in FIG. 3) may input or enter, through the login access point 304 (as shown in FIG. 3) displayed on the visual user interface 302 (as shown in FIG. 3), a login request for logging into the service 342 or 344 (as shown in FIG. 3). The login request may include a user identity data element and a login request data element. The user device 30 (as shown in FIG. 3) may be configured to transmit the login request to the authentication server 320 (as shown in FIG. 3).

After the user device 30 (as shown in FIG. 3) transmits the login request to the authentication server 320 (as shown in FIG. 3), the authentication server 320 (as shown in FIG. 3) may be configured to perform steps 410-470 of process 400 and other steps for digital authentication as described herein.

Step 410 may include receiving a login request from a user device. The login request may include a user identity data element and a login request data element. For example, the authentication server 320 (as shown in FIG. 3) may be configured to receive the login request including the user identity data element and the login request data element from the user device 30 (as shown in FIG. 3) through the login access point 304 (as shown in FIG. 3). The user identity data element may include at least one of a username, an account number, an email address, an identification number, or a public identifier associated with the user USR1 (as shown in FIG. 3), or a combination thereof. The login request data element may include at least one of a username, a phone number, a password, a PIN, an account number, an email address, a biometric authentication data element, a biometric identifier, an answer to a secure question, a two-factor authentication request data element, a two-factor authentication service identifier, a multi-factor authentication request data element, a multi-factor authentication service identifier, a public identifier associated with the user USR1 (as shown in FIG. 3), a private identifier associated with the user USR1 (as shown in FIG. 3), or any combination thereof.

In some embodiments, the user identity data element and the login request data element may be transmitted separately or together. The user identity data element and the login request data element may be transmitted over a secure network. The user identity data element and the login request data element may be encrypted before the transmission or during the transmission, or may be protected from interference and/or corruption during the transmission. The encryption may be symmetric encryption, such as the Advanced Encryption Standard (AES), Data Encryption Standard (DES), Triple DES (TDES), Blowfish, or Twofish. The encryption may be asymmetric encryption using a pair of public key and private key, such as the Rivest Shamir Adleman (RSA).

Step 420 may include retrieving, based on the login request, a supplemental data element associated with the user from a recording server. For example, the authentication server 320 (as shown in FIG. 3) may retrieve, based on the login request, the supplemental data element using the middleware directory service 330. For example, the authentication server 320 (as shown in FIG. 3) may be configured to transmit the user identity data element and/or the login request data element to the recording server 332 (as shown in FIG. 3). The recording server 332 (as shown in FIG. 3) may be configured to receive the user identity data element and/or login request data element from the authentication server 320 (as shown in FIG. 3). In some embodiments, the recording server 332 (as shown in FIG. 3) may be configured to parse, e.g., based on a request of the authentication server 320 (as shown in FIG. 3), the user identity data element and/or login request data element to generate a parsed user identity data element and/or parsed login request data element. The recording server 332 (as shown in FIG. 3) may be configured to transmit the user identity data element and/or login request data element to the database 334 (as shown in FIG. 3) for retrieving the supplemental data element corresponding to the user identity data element and/or login request data element. The database 334 (as shown in FIG. 3) may be configured to retrieve the supplemental data element based on the user identity data element and/or login request data element. The database 334 (as shown in FIG. 3) may be configured to transmit the retrieved supplemental data element to the recording server 332 (as shown in FIG. 3). The recording server 332 (as shown in FIG. 3) may be configured to receive the supplemental data element from the database 334 (as shown in FIG. 3). In some embodiments, the recording server 332 (as shown in FIG. 3) may be configured to decrypt the supplemental data element received from the database 334 (as shown in FIG. 3, and may be configured to transmit the decrypted supplemental data element to the authentication server 320 (as shown in FIG. 3), for the authentication server 320 (as shown in FIG. 3) to authenticate the user USR1 (as shown in FIG. 3). The authentication server 320 (as shown in FIG. 3) may be configured to receive the supplemental data element from the recording server 332 (as shown in FIG. 3).

In some embodiments, the authentication server 320 (as shown in FIG. 3) may be configured to parse the user identity data element and/or the login request data element to generate parsed user identity data element and/or the login request data element, to determine which part of the supplemental data element is to be retrieved or compared to. In some embodiments, the authentication server 320 (as shown in FIG. 3) may be configured to dictate to the user USR1 (as shown in FIG. 3), e.g., through the login access point 304, which part of the user identity data element and/or the login request data element is to be input or entered in the user input field to narrow which part of the supplemental data element is to be retrieved or compared to. In some embodiments, the authentication server 320 (as shown in FIG. 3) may be configured to perform a look-up to the database 334 (as shown in FIG. 3) based on the user identity data element and/or the login request data element, to determine which part of the supplemental data element is to be retrieved or compared to.

In some embodiments, the database 334 (as shown in FIG. 3) may be configured to store the supplemental data element associated with the user USR1 (as shown in FIG. 3). The supplemental data element may include at least one of a username, a password, a PIN, an account number, an email address, a biometric identifier, an answer to a security question, or credentials for a two-factor authentication service associated with the user USR1 (as shown in FIG. 3). In some embodiments, the supplemental data element may be stored in the database 334 (as shown in FIG. 3) using encryption, e.g., stored as an encrypted data element. In such embodiments, the supplemental data element may be retrieved by the database 334 (as shown in FIG. 3) or another component in the digital authentication system 300 using decryption. The encryption or decryption may be symmetric encryption, such as encryption using AES, DES, TDES, Blowfish, or Twofish. The encryption or decryption may be asymmetric encryption using a pair of public key and private key, such as RSA.

In some embodiments, the database 334 (as shown in FIG. 3) may be configured to store the supplemental data element using a hashing function. The hashing function may include Secure Hash Algorithm 256-bit (SHA-256). In some embodiments, the supplemental data element may correspond to a password, a phone number, an email address, a two-factor authentication service identifier, a biometric identifier, a public identifier associated with the user USR1 (as shown in FIG. 3), a private identifier associated with the user USR1 (as shown in FIG. 3), or any combination thereof. In some embodiments, the supplemental data element may include private information associated with the user USR1 (as shown in FIG. 3), which may be unknown or likely to be unknown by others. In some embodiments, the supplemental data element may be transmitted from the database 334 (as shown in FIG. 3) through a secured network by using encryption protocols for secure communication (e.g., Transport Layer Security (TLS), Secure Sockets Layer (SSL)), and/or other interference and/or corruption protection (e.g., cyclic redundancy check (CRC), forward error correction (FEC)).

Step 430 may include determining whether the login request data element matches the supplemental data element. For example, the authentication server 320 (as shown in FIG. 3) may be configured to determine whether the login request data element matches the supplemental data element. In some embodiments, the determination may include a character-to-character comparison between the login request data element and the supplemental data element. In some embodiments, the determination may include an image comparison. For example, the image comparison may be performed between a saved face image associated with the supplemental data element and an input face image associated with the login request data element. For another example, the image comparison may be performed between a saved fingerprint image associated with the supplemental data element and an input fingerprint image associated with the login request data element. In some embodiments, the determination may include a similarity calculation to evaluate the likelihood of the login request data element and the supplemental data element. The similarity calculation may include various statistical analyses, such as correlation coefficients, cosine similarity, or Euclidean distance, to quantitatively measure the degree of alignment between the data elements. Additionally, the similarity calculation may leverage comparisons against another login request data element exhibiting similar characteristics to refine the matching.

In some embodiments, the authentication server 320 (as shown in FIG. 3) may be configured to transmit an authentication required request, including alternative authentication options, to the user device 30 (as shown in FIG. 3). The authentication required request may be triggered by the login request, a determination that the login request data element matches the supplemental data element, a transaction request, or any other request requiring authenticating the user device 30 (as shown in FIG. 3). In such embodiments, the database 334 (as shown in FIG. 3) may be configured to store information associated with the user USR1 (as shown in FIG. 3) and/or the user device 30 (as shown in FIG. 3). The information may include the username of the user USR1 (as shown in FIG. 3), the account number of the user USR1 (as shown in FIG. 3), or the authentication options associated with the user USR1 (as shown in FIG. 3). In such embodiments, the authentication server 320 (as shown in FIG. 3) may be configured to retrieve other supplemental data elements before receiving an authentication request for responding to the authentication required request from the user device 30 (as shown in FIG. 3), and may be configured to use the other supplemental data elements to obtain data element(s) associated with the login request, the transaction request, and/or the authentication request.

Step 440 may include performing a two-factor authentication on the user device. For example, in response to a determination that the login request data element matches the supplemental data element, the authentication server 320 (as shown in FIG. 3) may be configured to perform the two-factor authentication on the user device 30 (as shown in FIG. 3), e.g., when receiving a two-factor authentication request from the user device 30 (as shown in FIG. 3) through the login access point 304 (as shown in FIG. 3). In some embodiments, the login access point 304 (as shown in FIG. 3) may be configured to not permit a password as an input of the authentication request. In such embodiments, the login access point 304 (as shown in FIG. 3) may be configured to provide authentication options, such as an OTP via a text message (e.g., short message service (SMS) message), via an email, via a call, or via an authentication application (e.g., Google Authenticator, Microsoft Authenticator), a biometric identifier, or a token, for authenticating the user device 30 (as shown in FIG. 3). The authentication request may include one of the authentication options. In some embodiments, the authentication server 320 (as shown in FIG. 3) may be configured to perform the two-factor authentication by transmitting a text PIN to the user device 30 and receiving the same texted PIN from the user device 30, e.g., when the one of the authentication options includes the OTP via a text message. In some embodiments, the authentication server 320 (as shown in FIG. 3) may be configured to perform the two-factor authentication by transmitting an email to an email address of the user USR1 (as shown in FIG. 3) and receiving the required action within the email (e.g., clicking a confirmation link or entering a verification code) from the user device 30 (as shown in FIG. 3), e.g., when the one of the authentication options includes the OTP via an email. In some embodiments, the authentication server 320 (as shown in FIG. 3) may be configured to perform the two-factor authentication by transmitting a verification code to the user USR1 (as shown in FIG. 3) through a call to a phone number of the user USR1 (as shown in FIG. 3) and receiving the same verification code from the user device 30 (as shown in FIG. 3), e.g., when the one of the authentication options includes the OTP via a call. In some embodiments, the authentication server 320 (as shown in FIG. 3) may be configured to perform the two-factor authentication by using one or more additional factors. The additional factors may include something the user USR1 (as shown in FIG. 3) knows (e.g., a secret answer to a question), something the user USR1 has (e.g., a secret token or a smart card number), something the user USR1 is (e.g., a fingerprint, a facial recognition, a retina or iris scan, or any other biometric identifier), and/or somewhere the user USR1 is (e.g., location information).

In response to a determination that the login request data element does not match the supplemental data element, the digital authentication system 300 may be configured to return to step 410 of process 400. For example, the authentication server 320 may be configured to cause the user device 30 (as shown in FIG. 3) to regenerate or update the login access point 304 (as shown in FIG. 3). The authentication server 320 may send a notification to the user device 30 requesting regeneration or an update to the login access point 304 (as shown in FIG. 3). The regenerated login access point may be the same as or different from the login access point 304 (as shown in FIG. 3). The authentication server 320 (as shown in FIG. 3) may be configured to request additional user input from the user device 30. The authentication server 320 (as shown in FIG. 3) may be configured to receive another login request from the user device 30 (as shown in FIG. 3) through the regenerated login access point. In some embodiments, the additional user input may be limited to the same type or class of the login request data element that is determined as not matching the supplemental data element. In some embodiments, the additional user input may be permissibly or required to be a different type or class of the login request data element, which is determined as not matching the supplemental data element. In some embodiments, the additional user input may be limited to a predetermined number of times, which may include, but is not limited to, three total inputs. Greater than or equal to the predetermined number of times unmatched user input may cause the user devices 30 and/or 31 (as shown in FIG. 3) associated with the user USR1 to be locked based on the username, the account number, or the login access point 304, 306, or 314 (as shown in FIG. 3) associated with the service provider 340 (as shown in FIG. 3).

Step 450 may include configuring the user device as authenticated in response to the two-factor authentication. For example, in response to a determination that the user device 30 (as shown in FIG. 3) is authenticated, e.g., by the authentication server 320 (as shown in FIG. 3) using the two-factor authentication, the authentication server 320 (as shown in FIG. 3) may be configured to configure the user device 30 (as shown in FIG. 3) as authenticated.

Step 460 may include configuring the first login mode as the authenticated status. For example, in response to configuring the user device 30 (as shown in FIG. 3) as authenticated, the authentication server 320 (as shown in FIG. 3) may be configured to configure the first login mode as the authenticated status (e.g., through the login access point 304).

Step 470 may include configuring the second login mode as the authenticated status. For example, in response to configuring the first login mode as the authenticated status, the authentication server 320 (as shown in FIG. 3) may be configured to configure the second login mode as the authenticated status (e.g., through the login access point 306 or 314).

In some embodiments, the login access points 306 or 314 (as shown in in FIG. 3) may be configured to not require receiving or accepting a user input as required by the login access points 304 (as shown in in FIG. 3), as the second login mode of the login access point 306 or 314 (as shown in FIG. 3) may be automatically configured as the authenticated status when the first login mode of the login access point 304 (as shown in FIG. 3) is configured as the authenticated status.

In some embodiments, the visual user interface driver (not shown) may be configured to adjust the login access point 304 (as shown in FIG. 3) displayed on the visual user interface 302 (as shown in FIG. 3) based on the first login mode. For example, the visual user interface driver (not shown) may be configured to generate the visual user interface 302 (as shown in FIG. 3) for displaying the login access point 304 (as shown in FIG. 3) with additional functionality (i.e., displaying more functionality compared to the login access point 304 (as shown in FIG. 3)) when the first login mode is configured as the authenticated status. For another example, the visual user interface driver (not shown) may be configured to generate the visual user interface 302 (as shown in FIG. 3) for displaying the login access point 304 (as shown in FIG. 3) with limited functionality (e.g., the same as the login access point 304 (as shown in FIG. 3)) when the first login mode is configured as the unauthenticated status.

The visual user interface driver (not shown) may be configured to adjust the login access point 306 or 314 (as shown in FIG. 3) displayed on the visual user interface 302 or 312 (as shown in FIG. 3) based on the second login mode. For example, the visual user interface driver (not shown) may be configured to generate the visual user interface 302 or 312 (as shown in FIG. 3) for displaying the login access point 306 or 314 (as shown in FIG. 3) with additional functionality (i.e., displaying more functionality compared to the login access point 306 or 314 (as shown in FIG. 3)) when the second login mode is configured as the authenticated status. For another example, the visual user interface driver (not shown) may be configured to generate the visual user interface 302 or 312 (as shown in FIG. 3) for displaying the login access point 306 or 314 (as shown in FIG. 3) with limited functionality (e.g., the same as the login access point 306 or 314 (as shown in FIG. 3)) when the second login mode is configured as the unauthenticated status.

The additional functionality may include a protected element associated with the login access point 304 or the login access point 306 or 314. The protected element may include private account information, private account functionality, private user data, private configuration settings, private purchase options, a facilitated user experience, or any combination thereof. In some embodiments, the login access point 304 may be configured to receive another login request. A type of the another login request may be the same as or different from a type of the login request. In some embodiments, the size requirements associated with user devices 30 and 31 (as shown in FIG. 3) may be programmed into the login access points 304, 306, and 314 (as shown in FIG. 3) and/or visual user interfaces 302 and 312 (as shown in FIG. 3), or may be separately programmed into a universal user interface guidelines associated with a unified authentication functionality.

According to process 400, when the user device 30 (as shown in FIG. 3) is authenticated and the first login mode is configured as the authenticated status, the login access point 304 (as shown in FIG. 3) may be configured to share its first login mode, as the authenticated status, with the login access point 306 or 314 (as shown in FIG. 3), which is associated with the same service provider 340 (as shown in FIG. 3) as the login access point 304 (as shown in FIG. 3). Thus, the second login mode of the login access point 306 or 314 (as shown in FIG. 3) may be configured as the authenticated status, without needing to perform all authentication steps required to log into the login access point 304 (as shown in FIG. 3). Thus, process 400 allows authenticating the user device 30 (as shown in FIG. 3) using a single set of unique, complex credentials, and security factor(s) or feature(s), granting secure access to all login access points associated with the same service provider.

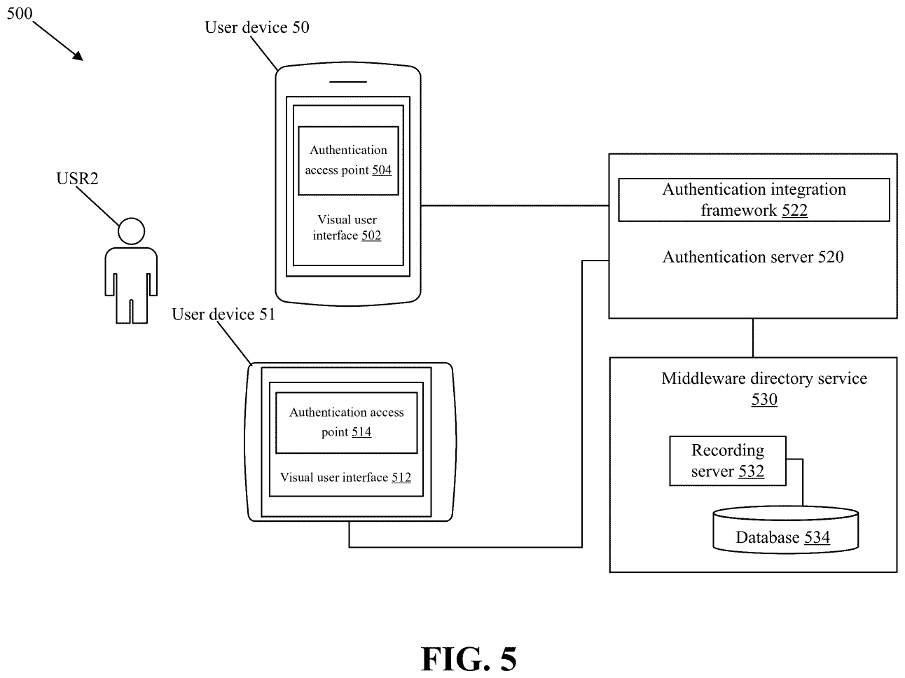

FIG. 5 illustrates an exemplary digital authentication system 500, according to some embodiments of the present disclosure. As shown in FIG. 5, the digital authentication system 500 may include user devices 50 and 51 associated with a user USR2, an authentication server 520, and a middleware directory service 530. The user devices 50 and 51 may include visual user interface drivers (not shown). The visual user interface drivers may be configured to generate visual user interfaces 502 and 512 displayed on the user devices 50 and 51, respectively. The visual user interfaces 502 and 512 may be configured to display authentication access points 504 and 514, respectively. In some embodiments, the user devices 50 and 51 may include a television, a tablet, a desktop computer, a laptop computer, a mobile phone, a wearable or portable electronic device, any device capable of computing and connecting to a network, or any combination thereof.

The authentication server 520 may include an authentication integration framework 522. The authentication integration framework 522 may be an authentication application programming interface (API). The authentication server 520 may be configured to communicate with the user devices 50 and 51 through the authentication integration framework 522. The communications may be performed through an electronic communication channel. The electronic communication channel may be, for example, a wired or unwired communication channel and may be configured to protect data transmitted through the electronic communication channel using a security protocol (e.g., encryption).

The middleware directory service 530 may include a recording server 532 and a database 534, for recording, organizing, and/or managing data and/or information (e.g., data and/or information about the user USR2, the user devices 50 and 51, and/or the authentication access points 504 and 514) associated with the digital authentication system 500. The recording server 532 may include an LDAP directory. The database 534 may include a unified directory such as an ORACLE Unified Directory (OUD) configured to provide scalable storage services. The recording server 532 may be configured to be hosted on the database 534. The communication between the recording server 532 and the authentication server 520, or between the recording server 532 and the database 534, may be performed on communication channels similar to the communication channel described above with respect to the user devices 50 and 51 and the authentication server 520. The authentication server 520 may be configured to query the recording server 532 to verify login or authentication information associated with the user USR2. For example, the recording server 532 may be configured to receive data retrieving or searching requests from the authentication server 520. The recording server 532 may be configured to transmit retrieved or searched data associated with the user USR2 to the authentication server 520.

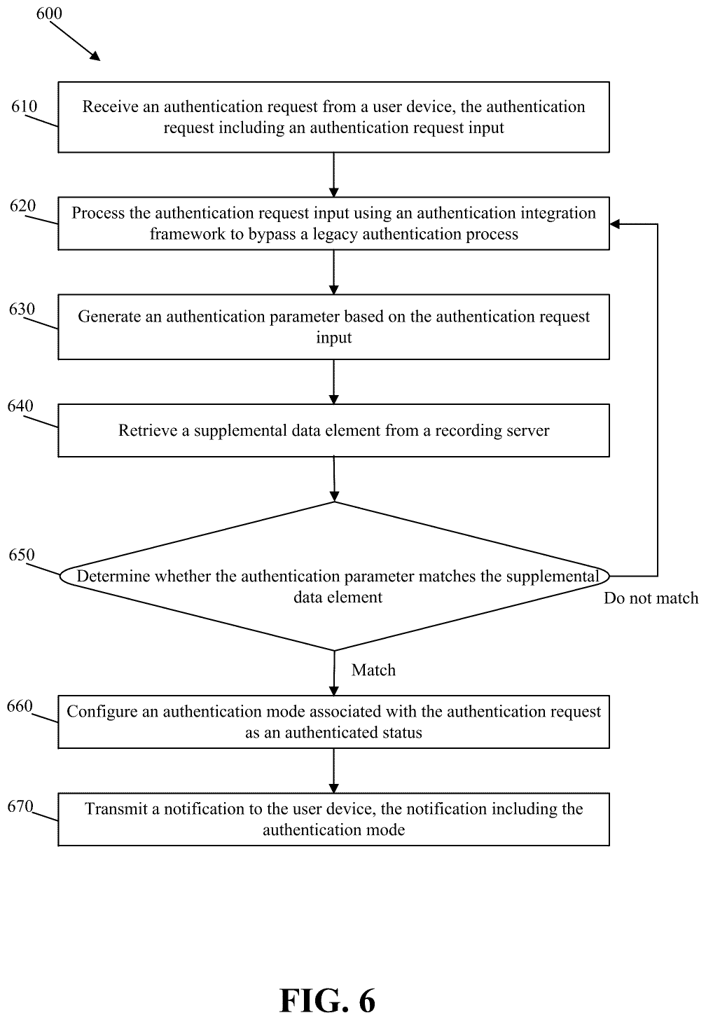

FIG. 6 illustrates a flow chart of an exemplary process 600 for digital authentication, which may be performed by exemplary digital authentication system 500 in FIG. 5, according to some embodiments of the present disclosure. At step 610, process 600 may include receiving an authentication request from a user device, the authentication request including an authentication request input. At step 620, process 600 may include processing the authentication request input using an authentication integration framework to bypass a legacy authentication process. At step 630, process 600 may include generating an authentication parameter based on the authentication request input. At step 640, process 600 may include retrieving a supplemental data element from a recording server. At step 650, process 600 may include determining whether the authentication parameter matches the supplemental data element. At step 660, process 600 may include, in response to a determination that the authentication parameter matches the supplemental data element, configuring an authentication mode associated with the authentication request as an authenticated status. At step 670, process 600 may include transmitting a notification to the user device, the notification including the authentication mode.

For example, the digital authentication system 500 (as shown in FIG. 5) may be configured to display the authentication access point 504 (as shown in FIG. 5) on the visual user interface 502 (as shown in FIG. 5). The authentication access point 504 (as shown in FIG. 5) may include an authentication mode. The authentication mode may be configured by default to indicate an unauthenticated status. The authentication access point 504 (as shown in FIG. 5) may include a user input field associated with the authentication request. The user input field may be configured to receive the authentication request input, which may include at least one of a username, a mobile phone number, a landline phone number, an email address, a sent code (e.g., OTP), an answer to a question, or a biometric identifier. In some embodiments, the authentication access point 504 (as shown in FIG. 5) may be configured to not require or not allow the receipt of the authentication request input, such as a password or PIN, that user USR2 (as shown in FIG. 5) must recall.

In some embodiments, the authentication access point 504 (as shown in FIG. 5) may include a control element, which may be implemented and displayed as a button to be clicked by the user USR2 to call a code (e.g., OTP) to the user device 51, for authenticating the user device 50 (as shown in FIG. 5). In some embodiments, the authentication access point 504 (as shown in FIG. 5) may be configured to automatically call the code. In some embodiments, the authentication integration framework 522 (as shown in FIG. 5) may be configured to generate and transmit the code to the user device 51 according to the call. In some embodiments, when the code is received by the user device 51 (as shown in FIG. 5), the user USR2 (as shown in FIG. 5) may input the code into the authentication access point 504 (as shown in FIG. 5) for the authentication integration framework 522 to verify the code to complete the authentication. In some embodiments, the authentication access point 504 (as shown in FIG. 5) may further include one or more control elements, which may be implemented and displayed as one or more radio buttons to be clicked to select a way to transmit the code. The way may include a text message (e.g., short message service (SMS) message), a phone call, an email, or an authentication application.

The user USR2 (as shown in FIG. 5), may input or enter, through the authentication access point 504 (as shown in FIG. 5) displayed on the visual user interface 502 (as shown in FIG. 5), the authentication request for authenticating the user device 50 (as shown in FIG. 5). The authentication request may include the authentication request input. The user device 50 (as shown in FIG. 5) may be configured to transmit the authentication request to the authentication server 520 (as shown in FIG. 5). After the user device 50 (as shown in FIG. 5) transmits the authentication request to the authentication server 520 (as shown in FIG. 5), the digital authentication system 500 (as shown in FIG. 5) may be configured to perform steps 610-670 of process 600 and other steps for digital authentication as described herein.

Step 610 may include receiving an authentication request from a user device, the authentication request including an authentication request input. For example, the authentication server 520 (as shown in FIG. 5) may be configured to receive the authentication request including the authentication request input from the user device 50 (as shown in FIG. 5) through the authentication access point 504 (as shown in FIG. 5). In some embodiments, the authentication request includes a two-factor authentication request.

Step 620 may include processing the authentication request input using an authentication integration framework to bypass a legacy authentication process. For example, the authentication integration framework 522 (as shown in FIG. 5) may be configured to process the authentication request input to bypass the legacy authentication process. In some embodiments, the authentication integration framework 522 (as shown in FIG. 5) may include a proprietary, third-party or customized authentication Software Development Kit (SDK) or API, such as a Transmit Auth SDK or API. In some embodiments, the legacy authentication process may include at least one of the following processes: interacting with an authentication service provider, such as Identity and Access Management (IAM), by transmitting credentials (e.g., username or password) of the user USR2 to the authentication service provider through a Service Function Locator (SFL) endpoint, to authenticate the user USR2 and generate an single sign-on (SSO) token for accessing SSO services; interacting with an OTP service provider, such as TWILIO, to generate and transmit an OTP to the user USR2, for the authentication service provider to verify or authenticate the input entered by the user USR2; interacting with a security or fraud detection service provider, such as TRUSTEER, to perform security or fraud checks for session or device access; interacting with a session management service provider, such as REDIS, to generate, transmit, and store a session identifier and a Mobile Device Management (MDM) identifier for session management.

Step 630 may include generating an authentication parameter based on the authentication request input. For example, the authentication integration framework 522 (as shown in FIG. 5) may be configured to process the authentication request input to generate the authentication parameter. In some embodiments, processing may include reformatting the authentication request input into a form usable by other components or devices of the digital authentication system 500 (as shown in FIG. 5). In some embodiments, processing may include parsing the authentication request input to generate one or more data elements for determining which part of supplemental data element is to be retrieved or compared to. In some embodiments, the data elements may be the authentication parameter. The authentication parameter may include at least one of a username, a mobile phone number, a landline phone number, an email address, a biometric identifier, or an answer to a security question.

Step 640 may include retrieving a supplemental data element from a recording server. For example, the authentication integration framework 522 (as shown in FIG. 5) may be configured to retrieve, based on the authentication parameter, the supplemental data element using the middleware directory service 530. In some embodiments, the authentication integration framework 522 (as shown in FIG. 5) may be configured to transmit the authentication parameter to the recording server 532 (as shown in FIG. 5). The recording server 532 (as shown in FIG. 5) may be configured to transmit the authentication parameter to the database 534 (as shown in FIG. 5) for retrieving the supplemental data element corresponding to the authentication parameter. The database 534 (as shown in FIG. 3) may be configured to retrieve the supplemental data element based on the authentication parameter. The database 534 (as shown in FIG. 5) may be configured to transmit the retrieved supplemental data element to the authentication integration framework 522 (as shown in FIG. 5) through the recording server 532 (as shown in FIG. 5). The authentication integration framework 522 (as shown in FIG. 5) may be configured to receive the supplemental data element from the recording server 532 (as shown in FIG. 5).

In some embodiments, the database 534 (as shown in FIG. 5) may be configured to store the supplemental data element associated with the user USR2 (as shown in FIG. 5). The supplemental data element may include at least one of a username, a password, a PIN, an account number, an email address, a biometric identifier, an answer to a security question, or a credential for a two-factor authentication service associated with the user USR2 (as shown in FIG. 5). In some embodiments, the database 534 may be configured to store the supplemental data element using encryption, such as stored as an encrypted data element. In such embodiments, the supplemental data element may be retrieved by the database 534 (as shown in FIG. 5) using decryption. The encryption or decryption may be symmetric encryption, such as the AES, DES, TDES, Blowfish, or Twofish. The encryption or decryption may be asymmetric encryption using a pair of public key and private key, such as the RSA. In some embodiments, the database 534 (as shown in FIG. 5) may be configured to store the supplemental data element using a hashing function. The hashing function may include SHA-256.

In some embodiments, the supplemental data element may correspond to a password, a phone number, an email address, a two-factor authentication service identifier, a biometric identifier, a public identifier associated with the user USR2 (as shown in FIG. 5), a private identifier associated with the user USR2 (as shown in FIG. 5), or any combination thereof. In some embodiments, the supplemental data element may include private information associated with the user USR2 (as shown in FIG. 5), which may be unknown or likely to be unknown by others (i.e., an attacker). In some embodiments, the supplemental data element may be transmitted from the database 534 (as shown in FIG. 5) via a secured network by using encryption protocols for secure communication (e.g., the TLS, the SSL), and/or other interference and/or corruption protection (e.g., CRC, FEC).

In some embodiments, the authentication integration framework 522 (as shown in FIG. 5) may be configured to transmit an authentication required request, including alternative authentication options, to the user device 50 (as shown in FIG. 5). The authentication required request may be triggered by a login request, a determination that login request data element matches supplemental data element, a transaction request, or any other request requiring authenticating the user device 50 (as shown in FIG. 5). In such embodiments, the authentication request may include one of the alternative authentication options. In such embodiments, the authentication integration framework 522 may be configured to cause the database 534 (as shown in FIG. 5) to store information associated with the user USR2 (as shown in FIG. 5), the user device 50 (as shown in FIG. 5), or an access point associated the login request, the transaction request, and/or the authentication request. In such embodiments, the authentication integration framework 522 (as shown in FIG. 5) may be configured to retrieve other supplemental data elements using the middleware directory service 530 before receiving the authentication request from the user device 50 (as shown in FIG. 5), or before generating the authentication parameter. The authentication integration framework 522 (as shown in FIG. 5) may be configured to use the other supplemental data elements to obtain one or more data elements associated with the login request, the transaction request, and/or the authentication request.

Step 650 may include determining whether the authentication parameter matches the supplemental data element. For example, the authentication integration framework 522 (as shown in FIG. 5) may be configured to determine whether the authentication parameter matches the supplemental data element. In some embodiments, the determination may include a character-to-character comparison, an image comparison, or a similarity calculation as described related to step 430.

Step 660 may include in response to a determination that the authentication parameter matches the supplemental data element, configuring an authentication mode associated with the authentication request as an authenticated status. For example, in response to the determination that the authentication parameter matches the supplemental data element, the authentication integration framework 522 (as shown in FIG. 5) may be configured to configure the authentication mode (e.g., associated with the authentication access point 504) as the authenticated status. In some embodiments, the authentication mode being configured as the authenticated status may cause the authentication access point 504 to instruct the visual user interface driver (not shown) to generate a landing interface or update the authentication access point 504, based on the authentication mode. For example, the visual user interface driver (not shown) may be configured to generate the visual user interface 502 (as shown in FIG. 5) for displaying the landing interface or the authentication access point 504 (as shown in FIG. 5) with additional functionality (e.g., protected element) when the authentication mode is configured as the authenticated status. For another example, the visual user interface driver (not shown) may be configured to generate the visual user interface 502 (as shown in FIG. 5) for displaying the landing interface or the authentication access point 504 (as shown in FIG. 5) with limited functionality when the authentication mode is configured as the unauthenticated status.

In some embodiments, the authentication integration framework 522 (as shown in FIG. 5) may be configured to provide a protected element associated with the authentication access point 504 (as shown in FIG. 5) to the user device 50 (as shown in FIG. 5) when the authentication mode is configured as the authenticated status. The protected element may include at least one of private account functionality, private user data, a private configuration setting, a private purchase option, or a facilitated user experience. In some embodiments, the authentication integration framework 522 (as shown in FIG. 5) may be configured to transmit a notification to a controlling server (not shown) for notifying the controlling server that the authentication mode is configured as the authenticated status. In such embodiments, the controlling server (not shown) may be configured to control the authentication access point 504 to instruct the visual user interface driver (not shown) to provide the landing interface or update the authentication access point 504 (as shown in FIG. 5) as described above.

Step 670 may include transmitting a notification to the user device, the notification including the authentication mode. For example, the authentication integration framework 522 (as shown in FIG. 5) may be configured to transmit the notification indicating that the authentication mode is configured as the authenticated status to the user device 50 (as shown in FIG. 5) associated with the authentication access point 504 (as shown in FIG. 5). In such embodiments, the notification may cause the authentication access point 504 to react to the authentication mode being configured as the authenticated status. For example, the authentication access point 504 may be configured to transmit a notification indicating that the authentication mode is configured as the authenticated status to the user device 50 (as shown in FIG. 5). In some embodiments, the visual user interface driver (not shown) may be configured to require additional action (e.g., user input, such as confirmation or approval) from the user USR2 (as shown in FIG. 5) through the visual user interface 502 (as shown in FIG. 5) before the visual user interface driver (not shown) updates the visual user interface 502 (as shown in FIG. 5). In some embodiments, the notification may simply cause the visual user interface driver (not shown) to update the visual user interface 502 (as shown in FIG. 5). In some embodiments, the visual user interface driver (not shown) may be configured to update the visual user interface 502 (as shown in FIG. 5) by displaying the authenticated mode, information showing that the user USR2 (as shown in FIG. 5) is logged in, more protected elements associated with the authentication access point 504 (as shown in FIG. 5), or more protected elements on the landing interface for permitting the user device 50 (as shown in FIG. 5) to access.

In some embodiments, in response to a determination that the authentication parameter does not match the supplemental data element, the authentication integration framework 522 (as shown in FIG. 5) may be configured to cause the authentication access point 504 (as shown in FIG. 5) to regenerate the visual user interface 502 (as shown in FIG. 5). In some embodiments, the regenerated visual user interface or authentication access point may be the same as or different from the visual user interface 502 (as shown in FIG. 5) or the authentication access point 504 (as shown in FIG. 5). In some embodiments, the authentication integration framework 522 (as shown in FIG. 5) may be configured to transmit another notification to the user device 50 (as shown in FIG. 5). The another notification may include a failed authentication request to the user device 50 (as shown in FIG. 5). In some embodiments, the authentication integration framework 522 (as shown in FIG. 5) may be configured to store the retrieved supplemental data element in a temporarily storage (such as a cache) after transmitting the another notification to the user device 50 (as shown in FIG. 5), to expedite the processing of an another authentication request associated with the user device 50 (as shown in FIG. 5). In some embodiments, the user device 50 (as shown in FIG. 5) may be permitted to transmit the another authentication request after receiving the another notification. In some embodiments, a type of the another authentication request may be the same as a type of the authentication request. For example, if the user USR2 (as shown in FIG. 5) input a fingerprint as the authentication request input, the user USR2 (as shown in FIG. 5) may be permitted to input the fingerprint as the another authentication request input. In some embodiments, a type of the another authentication request may be different from a type of the authentication request. For example, if the user USR2 (as shown in FIG. 5) input a fingerprint as the authentication request input, the user USR2 (as shown in FIG. 5) may be requested to input a facial recognition or a sent code as the another authentication request input. In some embodiments, the another authentication request may be any previously permissible authentication type. In some embodiments, the authentication access point 504 may be configured to provide additional authentication options with different types from any previously permissible authentication type to the user device 50 (as shown in FIG. 5), for the user device 50 to transmit the another authentication request according to the additional authentication options.

According to process 600, the digital authentication system 500 (as shown in FIG. 5) may be configured to use the authentication integration framework 522 (as shown in FIG. 5) to centrally, uniformly and integrally process the authentication request input received from the user device 50 (as shown in FIG. 5). Thus, the legacy authentication process that interacts with multiple service providers with different functionalities, as described in step 620, is not required, and can be bypassed.

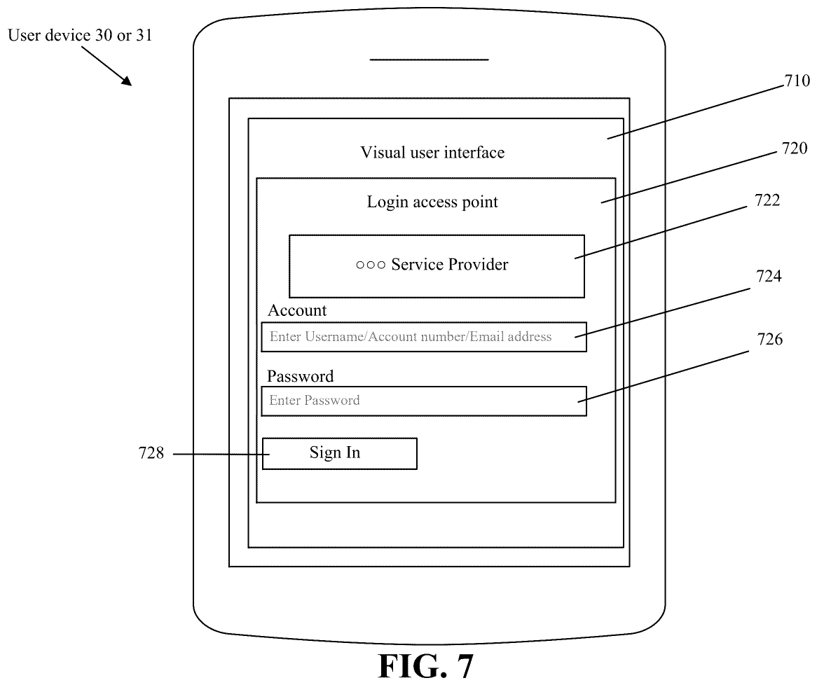

FIG. 7 illustrates a visual user interface of exemplary user device 30 or 31 of FIG. 3 for digital authentication, according to some embodiments of the present disclosure. As shown in FIG. 7, the user device 30 or 31 may include a visual user interface 710 (e.g., visual user interface 302 or 312 as shown in FIG. 3) configured to display a login access point 720 (e.g., login access point 304, 306, or 314 as shown in FIG. 3) to, for example, a user (e.g., USR1 as shown in FIG. 3). The login access point 720 may include a coloration or branding 722, user input fields 724 and 726, and a control element 728. The login access point 720 may be configured to prompt information to request input from the user (e.g., USR1 as shown in FIG. 3), input information entered by the user (e.g., USR1 as shown in FIG. 3), or output information from the digital authentication system 300 (as shown in FIG. 3) for the user (e.g., USR1 as shown in FIG. 3), as described in FIGS. 3 and 4. The coloration or branding 722 may be associated with a service provider (e.g., a bank) that may be configured to provide services (e.g., cloud services, such as bank services) associated with login access points. The user input fields 724 and 726 may be associated with a login credential request access point that may be configured to be input or entered, from or by the user (e.g., USR1 as shown in FIG. 3), login credentials, such as the user identity data element (e.g., username, account number, or email address) and the login request data element (e.g., password) as described in FIGS. 3 and 4. The control element 728 may be associated with a button (shown as “Sign In”) that may be configured to generate the login request including the user identity data element and the login request data element and to transmit the login request to an authentication server (e.g., authentication server 320 as shown in FIG. 3) for authenticating the user device 30 or 31, when being clicked by the user (e.g., USR1 as shown in FIG. 3).

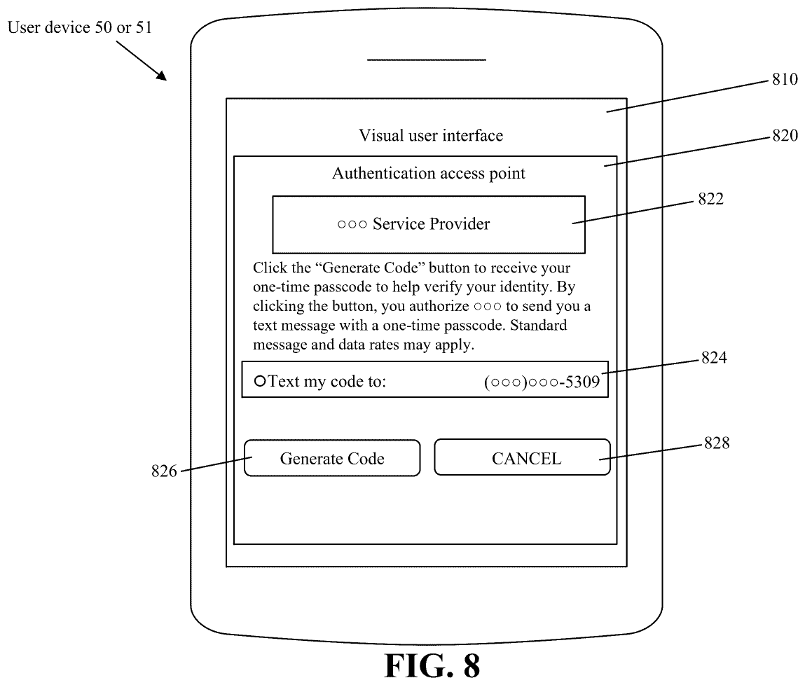

FIG. 8 illustrates a visual user interface of exemplary user device 50 or 51 of FIG. 5 for digital authentication, according to some embodiments of the present disclosure. As shown in FIG. 8, the user device 50 or 51 may include a visual user interface 810 (e.g., visual user interface 502 or 512 as shown in FIG. 3) configured to display an authentication access point 820 (e.g., authentication access point 504 or 514) to, for example, a user (e.g., USR2 as shown in FIG. 5). The authentication access point 820 may include a coloration or branding 822, a radio button 824, and control elements 826 and 828. The authentication access point 820 may be configured to prompt information to request a click from the user (e.g., USR2 as shown in FIG. 5) or to output information from the digital authentication system 500 (as shown in FIG. 5) for the user (e.g., USR2 as shown in FIG. 5), as described in FIGS. 5 and 6. The coloration or branding 822 may be associated with a service provider (e.g., a bank) that may be configured to provide services (e.g., cloud services, such as bank services) associated with login access points. The radio button 824 may be associated with a way to transmit a code (shown as “Text my code to: (∘∘∘) ∘∘∘-5309”) that may be configured to be clicked or selected, by the user (e.g., USR2 as shown in FIG. 5). The control element 826 may be associated with a button (shown as “Generate Code”) that may be configured to be clicked, by the user (e.g., USR2 as shown in FIG. 5), to generate the code to be sent through the way clicked or selected by the user (e.g., USR2 as shown in FIG. 5). When the code is received by the user (e.g., USR2 as shown in FIG. 5) through the way, the user (e.g., USR2 as shown in FIG. 5) may input the code into an updated authentication access point for an authentication server (e.g., authentication server 520 as shown in FIG. 5) to verify whether the sent code matches the input code, to complete the authentication process. The control element 828 may be associated with a button (shown as “CANCEL”) that may be configured to be clicked, by the user (e.g., USR2 as shown in FIG. 5), to cancel the authentication process.

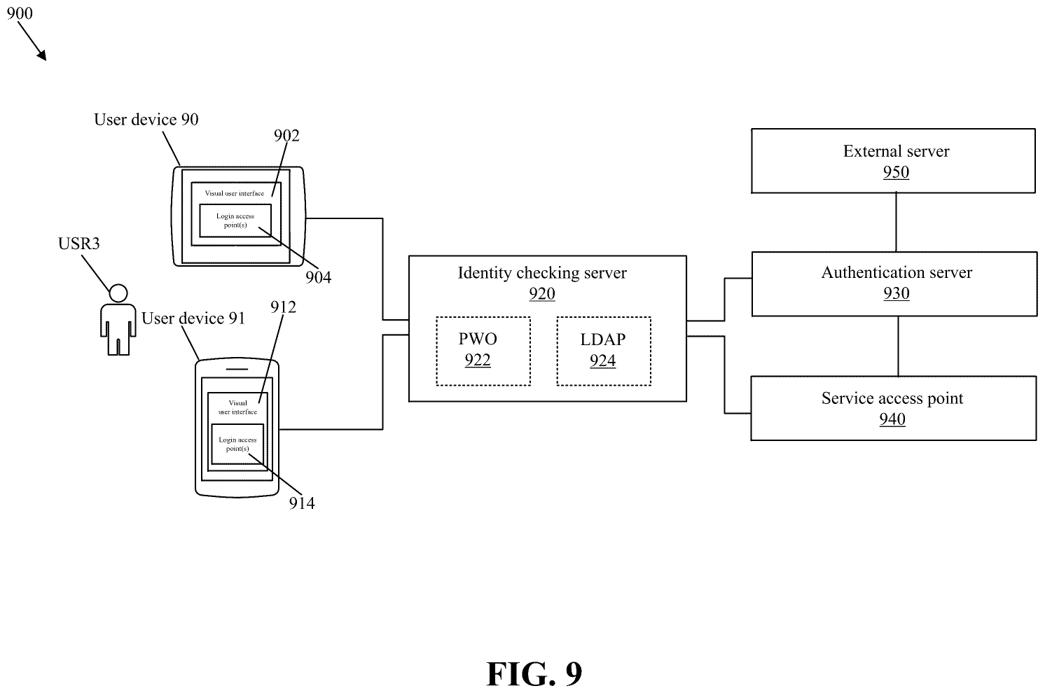

FIG. 9 illustrates an exemplary digital authentication system 900, according to some embodiments of the present disclosure. As shown in FIG. 9, the digital authentication system 900 may include user devices 90 and 91 associated with a user USR3, an identity checking server 920, an authentication server 930, a service access point 940, and an external server 950. The user devices 90 and 91 may include visual user interface drivers (not shown). The visual user interface drivers may be configured to generate visual user interfaces 902 and 912 displayed on the user devices 90 and 91, respectively. In some embodiments, the user devices 90 and 91 may include a television, a tablet, a desktop computer, a laptop computer, a mobile phone, a wearable or portable electronic device, any device capable of computing and connecting to a network, or any combination thereof. The visual user interface 902 may be configured to display a login access point 904 associated with a first cloud service (not shown). The visual user interfaces 912 may be configured to display a login access point 914 associated with a second cloud service (not shown). The visual user interfaces 902 and 912 and/or the login access points 904 and 914 may include security features configured to protect from copying the design features of the visual user interfaces 902 and 912 and/or the login access points 904 and 914. The visual user interface 902 may bear aesthetic similarities to the visual user interface 912.

The identity checking server 920 may include a password (PWO) directory 922 and/or an LDAP directory 924. The PWO directory 922 may be configured to store data (e.g., digital identity information of users) in a table or row format. The LDAP directory 924 may be configured to store data using an LDAP protocol. The LDAP protocol may be used to manage, access, retrieve, or search data stored in a directory housed on the LDAP directory 924. In some embodiments, the LDAP directory 924 may be configured to store data hierarchically to facilitate manage, access, retrieve, or search functionality. In some embodiments, the identity checking server 920 may be configured to communicate with the user device 90 or 91, e.g., through the login access points 904 or 914. In some embodiments, the identity checking server 920 may include an identity provider (IDP) server, such as OAuth, SAML, or OpenID Connect.

The authentication server 930 may be configured to communicate with the user device 90 or 91, e.g., through the identity checking server 920. The service access point 940 may be configured to communicate with the user device 90 or 91, e.g., through the identity checking server 920. In some embodiments, the service access point 940 may include a third-party service access point or may be created or controlled by the identity checking server 920. The service access point 940 may be integrated into the identity checking server 920 or the authentication server 930. The service access point 940 may be a unified access point, such as a SSO service portal, which may allow the user USR3 through the user device 90 or 91, to sign on to cloud services associated with the same service provider. The service access point 940 may be configured to use the identity checking server 920 to check the digital identity of the user USR3 without storing the digital identity of the user USR3. The external server 950 may be configured to communicate with the authentication server 930. In some embodiments, the external server 950 may include a digital identity (DI) authentication server. The authentication server 930 may be configured to use the external server 950 to authenticate the user USR3 through the user device 90 or 91. The above-mentioned communications may be performed through an electronic communication channel. The electronic communication channel may be, for example, a wired or unwired communication channel and may be configured to protect data transmitted through the electronic communication channel using a security protocol (e.g., encryption).

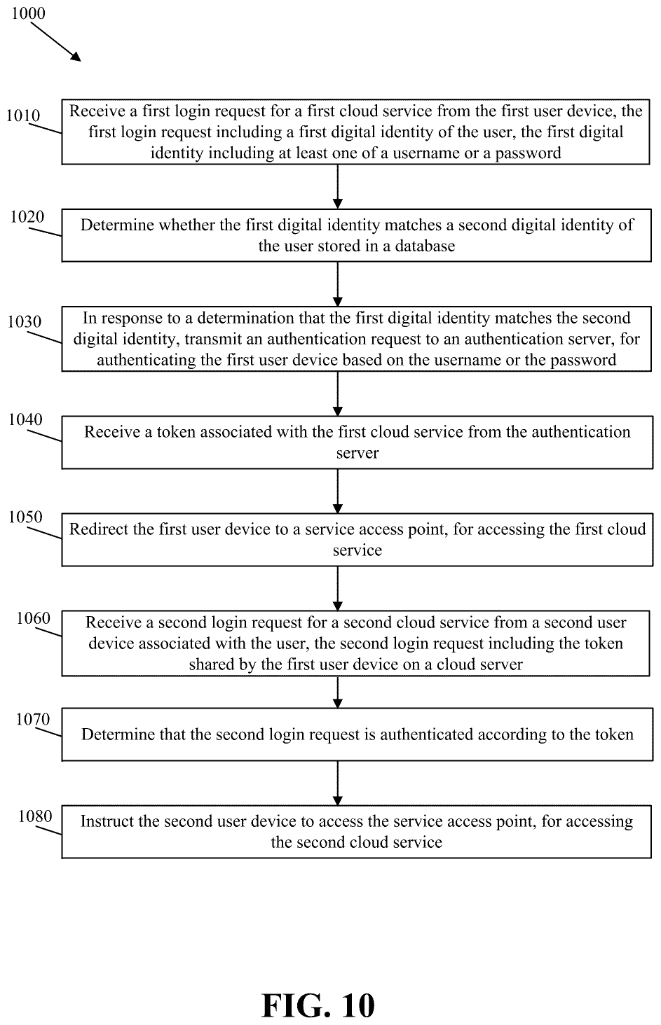

FIG. 10 illustrates a flow chart of an exemplary process 1000 for digital authentication, which may be performed by exemplary digital authentication system 900 in FIG. 9, according to some embodiments of the present disclosure. At step 1010, process 1000 may include receiving a first login request for a first cloud service from a first user device, wherein the first login request includes a first digital identity of the user, the first digital identity including at least one of a username or a password. At step 1020, process 1000 may include determining whether the first digital identity matches a second digital identity of the user stored in a database. At step 1030, process 1000 may include, in response to a determination that the first digital identity matches the second digital identity, transmitting an authentication request to an authentication server, for authenticating the first user device based on the username or the password. At step 1040, process 1000 may include receiving a token associated with the first cloud service from the authentication server. At step 1050, process 1000 may include redirecting the first user device to a service access point, for accessing the first cloud service. At step 1060, process 1000 may include receiving a second login request for a second cloud service from a second user device associated with the user, the second login request including the token shared by the first user device on a cloud server. At step 1070, process 1000 may include determining that the second login request is authenticated according to the token. At step 1080, process 1000 may include instructing the second user device to access the service access point, for accessing the second cloud service.

For example, the digital authentication system 900 (as shown in FIG. 9) may be configured to set up a user account of the user USR3 (as shown in FIG. 9), as described in FIG. 4. After the user account of the user USR3 (as shown in FIG. 9) is set up, the digital authentication system 900 may be configured to provide the login access point 904 (as shown in FIG. 9) associated with a first cloud service (not shown) provided by a service provider (not shown). The digital authentication system 900 may be configured to receive a first login request for the first cloud service from the user USR3 (as shown in FIG. 9) through the login access point 904 (as shown in FIG. 9). The first login request may include a digital identity of the user USR3 (as shown in FIG. 9). The user device 90 (as shown in FIG. 9) may be configured to transmit the first login request to the identity checking server 920 (as shown in FIG. 9). After the user device 90 (as shown in FIG. 9) transmits the first login request to the identity checking server 920 (as shown in FIG. 9), the identity checking server 920 (as shown in FIG. 9) may be configured to perform steps 1010-1080 of process 1000 and other steps for digital authentication as described herein.

Step 1010 may include receiving a first login request for a first cloud service from a first user device, wherein the first login request includes a first digital identity of the user, the first digital identity including at least one of a username or a password. For example, the identity checking server 920 (as shown in FIG. 9) may be configured to receive the first login request for the first cloud service from the user device 90 (as shown in FIG. 9) through the login access point 904 or 914 (as shown in FIG. 9). In some embodiments, the first login request may include the first digital identity of the user USR3 (as shown in FIG. 9). In some embodiments, the first digital identity of the user USR3 (as shown in FIG. 9) may include at least one of the username or the password. In some embodiments, the first cloud service may include a loan, a deposit, a trade, or any online bank service.

Step 1020 may include determining whether the first digital identity matches a second digital identity of the user stored in a database. For example, the identity checking server 920 (as shown in FIG. 9) may be configured to determine whether the first digital identity of the user USR3 (as shown in FIG. 9) matches a second digital identity of the user USR3 (as shown in FIG. 9) stored in the database. In some embodiments, the identity checking server 920 (as shown in FIG. 9) may be configured to determine whether the username, the password, other digital identity information, or any combination thereof matches corresponding stored username, stored password, other stored digital identity information, or any stored combination thereof, e.g., based on descriptions, examples, and/or embodiments related to step 430 in FIGS. 3 and 4, or step 650 in FIGS. 5 and 6. In some embodiments, the database may include the PWO directory 922 (as shown in FIG. 9) and/or the LDAP directory 924 (as shown in FIG. 9). In some embodiments, the identity checking server 920 (as shown in FIG. 9) may be configured to further determine whether at least one of conditions is met, before transmitting the authentication request to the authentication server 930 (as shown in FIG. 9). The at least one of conditions may include: whether an Internet Protocol (IP) address of the user device 90 (as shown in FIG. 9) is blacklisted; whether a block status of the user device 90 (as shown in FIG. 9) is blocked; whether a browser strike count of the user device 90 (as shown in FIG. 9) exceeds a predetermined number of times, such as three times for a given browser; whether a commercial experience migration status of the user device 90 (as shown in FIG. 9) is pending; whether a OTP feature of the user device 90 (as shown in FIG. 9) is enabled; whether an operator approval status of the user device 90 (as shown in FIG. 9) is approved; whether another token associated with another cloud service is expired; or whether an assigned service of the user device 90 (as shown in FIG. 9) is active. In response to a determination that the at least one of the conditions is met, transmitting the authentication request to the authentication server 930 (as shown in FIG. 9). In some embodiments, the identity checking server 920 (as shown in FIG. 9) may be configured to provide a list of digital identities of users (including the user USR3 (as shown in FIG. 9)) to the service provider (not shown), for the service provider to check whether each of the list of digital identities of the users is checked by the service provider.

Step 1030 may include, in response to a determination that the first digital identity matches the second digital identity, transmitting an authentication request to an authentication server, for authenticating the first user device based on the username or the password. For example, in response to a determination that the first digital identity matches the second digital identity, the identity checking server 920 (as shown in FIG. 9) may be configured to transmit or forward an authentication request to the authentication server 930 (as shown in FIG. 9), for authenticating the user device 90. The authentication server 930 (as shown in FIG. 9) may be configured to receive the authentication request from the identity checking server 920 (as shown in FIG. 9).

In some embodiments, the authentication server 930 (as shown in FIG. 9) may be configured to determine whether the user device 90 (as shown in FIG. 9) is authenticated by itself, by performing one or more authentication steps, such as two-factor authentication, multi-factor authentication, or biometric authentication. In response to a determination that the user USR3 through the user device 90 (as shown in FIG. 9) is authenticated, the authentication server 930 (as shown in FIG. 9) may be configured to generate a first token associated with the first cloud service. In some other embodiments, the authentication server 930 (as shown in FIG. 9) may be configured to transmit the authentication request to the external server 950 (as shown in FIG. 9), for the external server 950 (as shown in FIG. 9) to authenticate the user device 90 (as shown in FIG. 9). The external server 950 (as shown in FIG. 9) may be configured to receive the authentication request from the authentication server 930 (as shown in FIG. 9). The external server 950 (as shown in FIG. 9) may be configured to determine whether the user device 90 (as shown in FIG. 9) is authenticated by performing one or more authentication steps, such as two-factor authentication, multi-factor authentication, or biometric authentication. In response to a determination that the user device 90 (as shown in FIG. 9) is authenticated, the external server 950 (as shown in FIG. 9) may be configured to generate the first token associated with the first cloud service and transmit the first token associated with the first cloud service to the authentication server 930 (as shown in FIG. 9). In some embodiments, the authentication server 930 (as shown in FIG. 9) or the external server 950 (as shown in FIG. 9) may be configured to perform the authentication steps by using cloud-based artificial intelligence and/or machine learning to distinguish genuine login or authentication requests from attempted fraudulent login or authentication requests. The authentication server 930 (as shown in FIG. 9) may be configured to transmit the first token associated with the first cloud service to the identity checking server 920 (as shown in FIG. 9), for the identity checking server 920 (as shown in FIG. 9) to determine that future login requests for cloud services associated with the same service provider from the user device 90 or 91 (as shown in FIG. 9) are authenticated.

Step 1040 may include receiving a token associated with the first cloud service from the authentication server. For example, the identity checking server 920 (as shown in FIG. 9) may be configured to receive the first token associated with the first cloud service from the authentication server 930 (as shown in FIG. 9). In some embodiments, in response to receiving the first token associated with the first cloud service from the authentication server 930 (as shown in FIG. 9), the identity checking server 920 (as shown in FIG. 9) may be configured to transmit the first token associated with the first cloud service to the user device 90 (as shown in FIG. 9). The user device 90 (as shown in FIG. 9) may be configured to store the first token associated with the first cloud service in the user device 90 (as shown in FIG. 9), such as in a session of a browser engine through the visual user interface 902 (as shown in FIG. 9). The user device 90 (as shown in FIG. 9) may be configured to further upload the first token to a cloud server, for storing and sharing the token to other login access points associated with the same service provider. In some embodiments, the first token may include at least one of an access token or a refresh token. In some embodiments, the identity checking server 920 (as shown in FIG. 9) or the user device 90 (as shown in FIG. 9) may be configured to further request an update access token from the authentication server 930 (as shown in FIG. 9) using the refresh token, when the access token expires. The identity checking server 920 (as shown in FIG. 9) or the user device 90 (as shown in FIG. 9) may receive the updated access token, when the refresh token is validated by the authentication server 930 (as shown in FIG. 9). The identity checking server 920 (as shown in FIG. 9) or the user device 90 (as shown in FIG. 9) may update the access token using the updated access token. The identity checking server 920 (as shown in FIG. 9) may determine that the second login request is authenticated according to the updated access token.

Step 1050 may include redirecting the first user device to a service access point, for accessing the first cloud service. For example, the identity checking server 920 (as shown in FIG. 9) may be configured to redirect the user device 90 to the service access point 940 (as shown in FIG. 9), to allow the user device 90 (as shown in FIG. 9) to access the first cloud service and/or other cloud services associated with the same service provider as the first cloud service.

Step 1060 may include receiving a second login request for a second cloud service from a second user device associated with the user, the second login request including the token shared by the first user device on a cloud server. For example, the digital authentication system 900 (as shown in FIG. 9) may be configured to receive a second login request for a second cloud service from the user USR3 (as shown in FIG. 9) through the login access point 914 (as shown in FIG. 9). The second login request may include the first token shared by the user device 90 (as shown in FIG. 9) on the cloud server. In some embodiments, the first cloud service and the second cloud service may be the same cloud service. In some embodiments, the first cloud service and the second cloud service may be different cloud services provided by the same service provider. In such embodiments, step 1060 may include proceeding with step 1070. In some other embodiments, the first cloud service and the second cloud service may be provided by different service providers. In such embodiments, step 1060 may include returning to step 1030, which includes further authenticating the user USR3 (as shown in FIG. 9) through the login access point 914 (as shown in FIG. 9) to receive a second token associated with the second cloud service from the authentication server 930 (as shown in FIG. 9). In some embodiments, the cloud server may be the same as the external server 950 (as shown in FIG. 9). In some embodiments, the cloud server may be different from the external server 950 (as shown in FIG. 9). The cloud server may provide the first token to the authentication server 930 (as shown in FIG. 9).

Step 1070 may include determining that the second login request is authenticated according to the token. For example, the identity checking server 920 (as shown in FIG. 9) may be configured to determine that the user USR3 (as shown in FIG. 9) through the login access point 914 (as shown in FIG. 9) is authenticated according to the first token.

Step 1080 may include instructing the second user device to access the service access point, for accessing the second cloud service. For example, the identity checking server 920 (as shown in FIG. 9) may be configured to instruct the user device 91 (as shown in FIG. 9) to access the service access point 940 (as shown in FIG. 9), to allow the user device 91 (as shown in FIG. 9) to access the second cloud service and/or other cloud service(s) associated with (e.g., have) the same service provider as the first or second cloud service.

According to process 1000, the identity checking server 920 (as shown in FIG. 9) may not repeat the determination step as step 1020 and/or the authentication step as step 1030 for authenticating the user device 90 or 91 (as shown in FIG. 9) requesting for the cloud service(s) associated with the same service provider, based on the shared first token. Thus, a login process that does not rely solely on complex passwords is provided. The user device 90 or 91 (as shown in FIG. 9) may be configured to further access other cloud services associated with the same service provider as the first or second cloud service by accessing the service access point 940 (as shown in FIG. 9). Thus, process 1000 allows the user USR3 (as shown in FIG. 9) to verify the digital identity with a single set of unique, complex credentials, and security features, granting secure access to all cloud services associated with the same service provider.

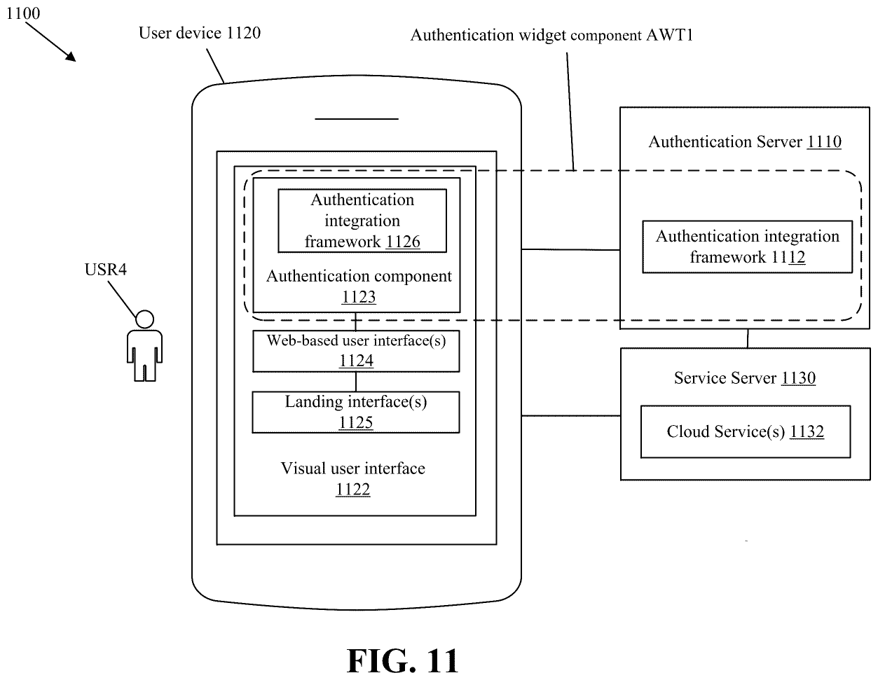

FIG. 11 illustrates an exemplary digital authentication system 1100, according to some embodiments of the present disclosure. As shown in FIG. 11, the digital authentication system 1100 may include an authentication server 1110, a user device 1120 associated with a user USR4, and a service server 1130 providing at least one cloud service 1132. The authentication server 1110 may include an authentication integration framework 1112. The authentication integration framework 1112 may be an authentication API. The user device 1120 may include a visual user interface driver (not shown) configured to generate the visual user interface 1122 displayed on the user device 1120. The visual user interface 1122 may embed an authentication component 1123, may include at least one web-based user interface 1124, and may include at least one landing interface 1125. The authentication component 1123 may include an authentication integration framework 1126. The web-based user interface(s) 1124 may display at least one web-based application (APP) corresponding to the cloud service(s) 1132. The landing interface(s) 1125 may be home page(s) or dashboard(s) for the cloud service(s) 1132.

The user device 1120 may include a television, a tablet, a desktop computer, a laptop computer, a mobile phone, a wearable or portable electronic device, any device capable of computing and connecting to a network, or any combination thereof. The web-based user interface(s) 1124 or the landing interface(s) 1125 may be generated according to at least one web framework. The web framework(s) may include a component-based modular framework, a front-end framework, or a JavaScript-based framework. The component-based modular framework, such as React, may provide a modular and highly scalable approach to building web applications. The front-end framework, such as Bootstrap, may provide responsive design and may be built based on Hyper Text Markup Language (HTML), Cascading Style Sheets (CSS), and/or JavaScript. The JavaScript-based framework, such as Angular, or React, or third-party or customized tools such as Comex Angular, MicroApp, or PWO IDP jQuery, may provide a comprehensive toolset for building dynamic single-page applications. The authentication component 1123 may include a web-based component. The web-based component may be configured to process tasks, such as login or authentication functionality. The web-based component may include a third-party or customized (e.g., Transmit) Angular login web-based component. The authentication integration framework 1126 may be configured to facilitate seamless integration of authentication processes, such as user login, user authentication, token management, and secure communication with backend services. The authentication integration framework 1126 may include a third-party or customized (e.g., Transmit) JavaScript SDK. The authentication component 1123, the authentication integration framework 1126, and the authentication integration framework 1112 may be used as an authentication widget AWT1 for processing login or authentication requests from the user device 1120. The service server 1130 may include a service provider, such as a bank. The service server 1130 may enable the user USR4 to log into or access one of cloud service(s) 1132 via corresponding web-based APP(s) displayed on the web-based interface(s) 1124.

The user device 1120 may be configured to communicate with the authentication server 1110 through the authentication component 1123. The authentication server 1110 may be configured to communicate with the user device 1120 through the authentication integration framework 1112. These communications may be performed through an electronic communication channel. The electronic communication channel may be, for example, a wired or unwired communication channel and may protect data transmitted through the electronic communication channel using a security protocol (e.g., encryption).

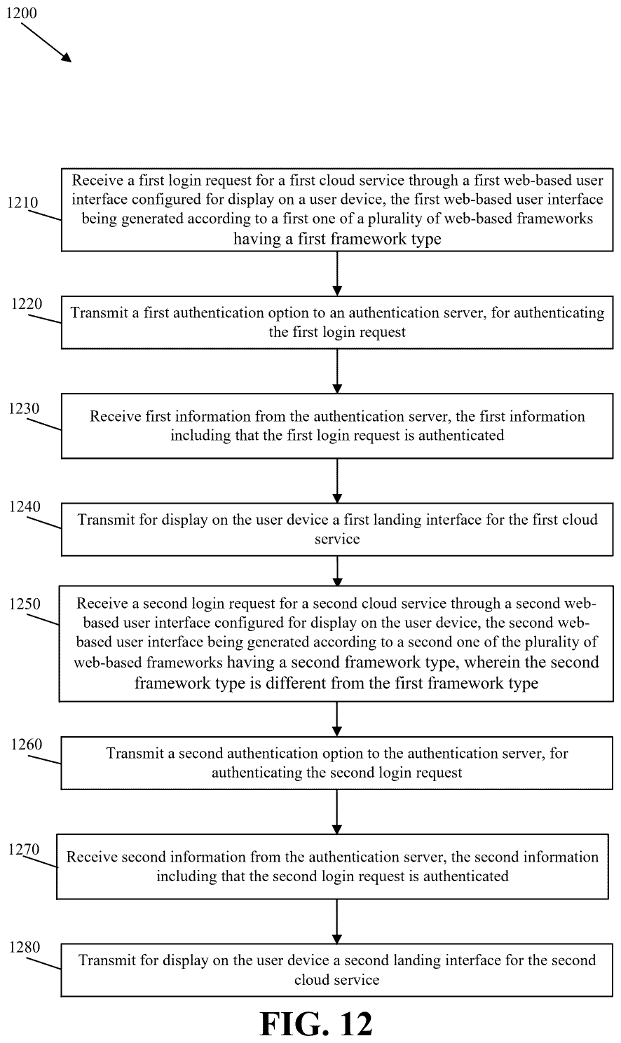

FIG. 12 illustrates a flow chart of an exemplary process 1200 for digital authentication, which may be performed by the exemplary digital authentication system 1100 in FIG. 11, according to some embodiments of the present disclosure. At step 1210, process 1200 may include receiving a first login request for a first cloud service through a first web-based user interface configured for display on a user device, the first web-based user interface being generated according to a first one of a plurality of web-based frameworks having a first framework type. At step 1220, process 1200 may include transmitting a first authentication option to an authentication server, for authenticating the first login request. At step 1230, process 1200 may include receiving first information from the authentication server, the first information including that the first login request is authenticated. At step 1240, process 1200 may include transmitting for display on the user device a first landing interface for the first cloud service. At step 1250, process 1200 may include receiving a second login request for a second cloud service through a second web-based user interface configured for display on the user device, the second web-based user interface being generated according to a second one of the plurality of web-based frameworks having a second framework type, wherein the second framework type is different from the first framework type. At step 1260, process 1200 may include transmitting a second authentication option to the authentication server, for authenticating the second login request. At step 1270, process 1200 may include receiving second information from the authentication server, the second information including that the second login request is authenticated. At step 1280, process 1200 may include transmitting for display on the user device a second landing interface for the second cloud service.

For example, the digital authentication system 1100 may be configured to set up a user account of the user USR4 (as shown in FIG. 11), as described in FIG. 4, before the user first accesses or logs into one of the cloud service(s) 1132 (as shown in FIG. 11) provided by the service server 1130 (as shown in FIG. 11), e.g., via corresponding web-based APP(s) displayed on the web-based interface(s) 1124 (as shown in FIG. 11). After the user account of the user USR4 (as shown in FIG. 11) is set up, the digital authentication system 1100 may be configured to provide a first one of the web-based user interface(s) 1124 (as shown in FIG. 11) associated with a first one of the cloud service(s) 1132 (as shown in FIG. 11). The digital authentication system 1100 may be configured to receive, from the user USR4 (as shown in FIG. 11) through the first one of the web-based user interface(s) 1124 (as shown in FIG. 11), a first login request for the first one of the cloud service(s) 1132 (as shown in FIG. 11). The first login request may include a digital identity of the user USR4 (as shown in FIG. 11). The digital identity of the user USR4 (as shown in FIG. 11) may include a username and a password. The user device 1120 (as shown in FIG. 11) may be configured to transmit the first login request to the authentication server 1110 (as shown in FIG. 11) by initiating the authentication component 1123 (as shown in FIG. 11). The authentication component 1123 may be configured to perform steps 1210-1280 of Process 1200 and other steps for digital authentication as described herein.

Step 1210 may include receiving a first login request for a first cloud service through a first web-based user interface configured for display on a user device, the first web-based user interface being generated according to a first one of a plurality of web-based frameworks having a first framework type. For example, the authentication component 1123 (as shown in FIG. 11) may be configured to receive the first login request for the first one of the cloud service(s) 1132 (as shown in FIG. 11) through the first one of the web-based user interface(s) 1124 (as shown in FIG. 11). The first one of the web-based user interface(s) 1124 (as shown in FIG. 11) may be generated according to the first one of the plurality of web-based frameworks having a first framework type.

Step 1220 may include transmitting a first authentication option to an authentication server, for authenticating the first login request. For example, in response to receiving the first login request, the authentication component 1123 (as shown in FIG. 11) may initiate the authentication integration framework 1126 (as shown in FIG. 11), to transmit the first authentication option to the authentication server 1110 (as shown in FIG. 11), for authenticating the first login request. In some embodiments, initiating of the authentication integration framework 1126 (as shown in FIG. 11) may include configuring the authentication integration framework 1126 (as shown in FIG. 11) with a plurality of parameters, for connecting to the authentication server 1110 (as shown in FIG. 11), and/or may include reporting a result of initiating the authentication integration framework 1126 (as shown in FIG. 11) (e.g., asynchronously) to a provided initiation handler, such as a callback function or an event handler, configured to verify a correctness of the plurality of parameters used in connecting to the authentication server 1110 (as shown in FIG. 11). The parameters may include a uniform resource locator (URL) of the authentication server 1110 (as shown in FIG. 11), an app identifier or token identifier of the first one of the cloud service(s) 1132 (as shown in FIG. 11. In some embodiments, the first authentication option may include at least one of single-factor authentication, two-factor authentication, multi-factor authentication, a risk-based authentication, fast-factor authentication, fast identity online authentication, or OTP authentication. In some embodiments, the first authentication option may be selected by the user USR4 (as shown in FIG. 11) through the first one of the web-based user interface(s) 1124 (as shown in FIG. 11). In some embodiments, the first login request may include the first authentication option.

The authentication server 1110 (as shown in FIG. 11) may be configured to receive, through the authentication integration framework 1112 (as shown in FIG. 11), the first login request from the user device 1120 (as shown in FIG. 11). The authentication server 1110 (as shown in FIG. 11) may be configured to determine whether the first login request is authenticated based on the authentication option. In some embodiments, the authentication server 1110 (as shown in FIG. 11) may be configured to determine whether the first login request is authenticated based on one or more identity journeys determined based on the digital identity of the user USR4 (as shown in FIG. 11) or other information associated with the user USR4 (as shown in FIG. 11). The other information may include a type of the user device 1120 (as shown in FIG. 11) (e.g., whether the user device 1120 is recognized), a location of the user device 1120 (as shown in FIG. 11), a behavior of the user device 1120 (as shown in FIG. 11), an activity history of the user device 1120 (as shown in FIG. 11), and a risk level of the user device 1120 (as shown in FIG. 11). For example, when the user device 1120 (as shown in FIG. 11) is a trusted device at the user's home, a basic identity journey (e.g., password) may be used for authenticating the user device 1120 (as shown in FIG. 11) based on low-risk geolocation and recognized user device. When the user device 1120 (as shown in FIG. 11) is an untrusted device overseas, an enhanced identity journey (e.g., password and two-factor authentication) may be used for authenticating the user device 1120 (as shown in FIG. 11) based on high-risk geolocation and unrecognized device. When the first login request is for accessing financial records, an enhanced identity journey (e.g., password, two-factor authentication, and/or biometric authentication) may be used for authenticating the user device 1120 (as shown in FIG. 11) based on a sensitive accessing. In response to a determination that the first login request (e.g., from the user device 1120) is authenticated, the authentication server 1110 (as shown in FIG. 11) may be configured to transmit, through the authentication integration framework 1112 (as shown in FIG. 11), first token(s) to the user device 1120 (as shown in FIG. 11).

Step 1230 may include receiving first information from the authentication server, the first information including that the first login request is authenticated. For example, the authentication component 1123 (as shown in FIG. 11) may be configured to receive, through the authentication integration framework 1126 (as shown in FIG. 11), the first token(s) associated with the first one of the cloud service(s) 1132 (as shown in FIG. 11) and/or authentication information from the authentication server 1110 (as shown in FIG. 11). The authentication component 1123 (as shown in FIG. 11) may be configured to further display a login success status or a notification of the user USR4 (as shown in FIG. 11) being authenticated on the first one of the web-based user interface 1124 (as shown in FIG. 11). In some embodiments, the authentication component 1123 (as shown in FIG. 11) may be configured to store the first token(s) associated with the first one of the cloud service(s) 1132 (as shown in FIG. 11) in a session of a browser engine through the first one of the web-based user interface(s) 1124 (as shown in FIG. 11). In some embodiments, the authentication component 1123 (as shown in FIG. 11) may be configured to clear the first token(s) when the session or the browser engine is closed. In some embodiments, the authentication information may indicate that the first login request from the user device 1120 (as shown in FIG. 11) is authenticated.

Step 1240 may include transmitting for display on the user device a first landing interface for the first cloud service. For example, the authentication component 1123 (as shown in FIG. 11) may be configured to display the first one of the landing interface(s) 1125 for the first one of the cloud service(s) 1132, e.g., through the first one of the web-based user interface(s) 1124 (as shown in FIG. 11).

Step 1250 may include receiving a second login request for a second cloud service through a second web-based user interface configured for display on the user device, the second web-based user interface being generated according to a second one of the plurality of web-based frameworks having a second framework type, wherein the second framework type is different from the first framework type. For example, the authentication component 1123 (as shown in FIG. 11) may be configured to receive the second login request for the second one of the cloud service(s) 1132 (as shown in FIG. 11) through the second one of the web-based user interface(s) 1124 (as shown in FIG. 11). The second one of the web-based user interface(s) 1124 (as shown in FIG. 11) may be generated according to a second one of the plurality of web-based frameworks having a second framework type. The second framework type is different from the first framework type.

Step 1260 may include transmitting a second authentication option to the authentication server, for authenticating the second login request. For example, in response to receiving the second login request, the authentication component 1123 (as shown in FIG. 11) may be configured to initiate the authentication integration framework 1126 (as shown in FIG. 11), to transmit the second authentication option to the authentication server 1110 (as shown in FIG. 11), for authenticating the second login request. In some embodiments, the second authentication option may include at least one of the single-factor authentication, the two-factor authentication, the multi-factor authentication, the risk-based authentication, the fast-factor authentication, the fast identity online authentication, or the OTP authentication. In some embodiments, the second login request may include the second authentication option.

The authentication server 1110 (as shown in FIG. 11) may be configured to receive, through the authentication integration framework 1112 (as shown in FIG. 11), the second login request from the user device 1120 (as shown in FIG. 11). The authentication server 1110 (as shown in FIG. 11) may be configured to determine whether the second login request is authenticated based on the authentication option, or based on one or more identity journeys determined based on the digital identity of the user USR4 (as shown in FIG. 11) or other information associated with the user USR4 (as shown in FIG. 11) as described in step 1220. In response to a determination that the second login request (e.g., from the user device 1120) is authenticated, the authentication server 1110 (as shown in FIG. 11) may be configured to transmit, through the authentication integration framework 1112 (as shown in FIG. 11), second token(s) to the user device 1120 (as shown in FIG. 11).

Step 1270 may include receiving second information from the authentication server, the second information including that the second login request is authenticated. For example, the authentication component 1123 (as shown in FIG. 11) may be configured to receive, through the authentication integration framework 1126 (as shown in FIG. 11), the second token(s) associated with the second one of the cloud service(s) 1132 (as shown in FIG. 11) and/or authentication information from the authentication server 1110 (as shown in FIG. 11). In some embodiments, the authentication component 1123 (as shown in FIG. 11) may be configured to store the second token(s) associated with the second one of the cloud service(s) 1132 (as shown in FIG. 11) in a session of a browser engine through the second one of the web-based user interface(s) 1124 (as shown in FIG. 11). In some embodiments, the authentication component 1123 (as shown in FIG. 11) may be configured to clear the second token(s) when the session or the browser engine is closed. In some embodiments, the authentication information may indicate that the second login request from the user device 1120 (as shown in FIG. 11) is authenticated.

Step 1280 may include transmitting for display on the user device a second landing interface for the second cloud service. For example, the authentication component 1123 (as shown in FIG. 11) may be configured to display a second one of the landing interface(s) 1125 for the second one of the cloud service(s) 1132, e.g., through the second one of the web-based user interface 1124 (as shown in FIG. 11).

In some embodiments, the authentication component 1123 (as shown in FIG. 11) may be configured to receive a first logout request through the first one of the landing interface(s) 1125, after display of the first one of the landing interface(s) 1125. The authentication component 1123 (as shown in FIG. 11) may be configured to transmit for display on the user device 1120 (as shown in FIG. 11) the first one of the web-based user interface 1124 (as shown in FIG. 11) for the first cloud service in response to the first logout request. In some other embodiments, the authentication component 1123 (as shown in FIG. 11) may be configured to receive a second logout request through the second one of the landing interface(s) 1125, after display of the second one of the landing interface(s) 1125. The authentication component 1123 (as shown in FIG. 11) may be configured to transmit for display on the user device 1120 (as shown in FIG. 11) the second one of the web-based user interface 1124 (as shown in FIG. 11) for the second cloud service in response to the second logout request.

According to process 1200, the authentication component 1123 (as shown in FIG. 11) may be used to receive login requests from the user USR4 (as shown in FIG. 11) through the web-based user interfaces generated with various web-based frameworks. Thus, the authentication component 1123 (as shown in FIG. 11) can centralize the login process and the authentication process, ensuring consistent and streamlined functionality across all the web-based user interfaces. This approach provides a unified, consistent, and streamlined login or authentication experience across all the web-based user interfaces built with various web-based frameworks, and allows developers to standardize development or implementation of the web-based user interfaces. Thus, a unified login or authentication functionality that enables developers to create a consistent login experience across all the web-based user interfaces is provided.

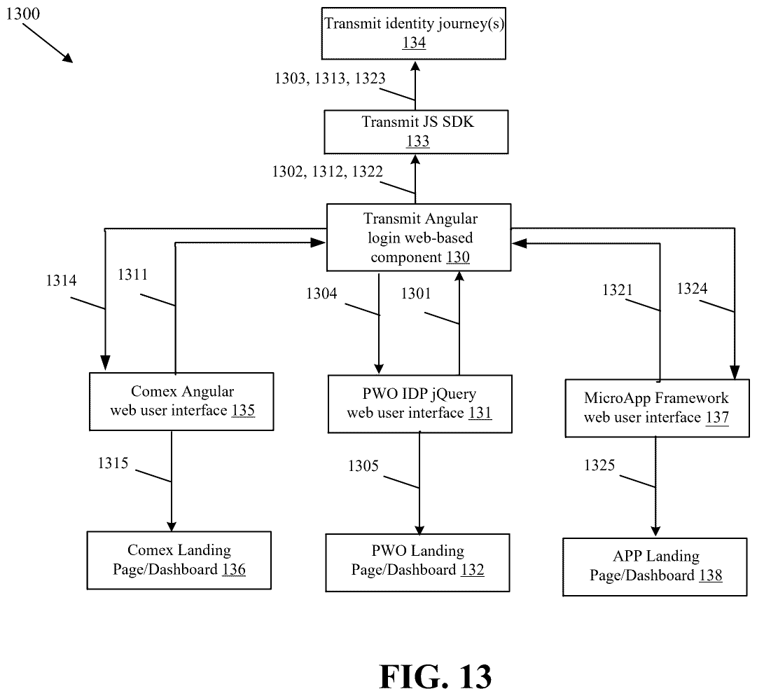

FIG. 13 illustrates an exemplary implementation 1300 of an exemplary process 1200 in FIG. 12 for digital authentication, according to some embodiments of the present disclosure. As shown in FIG. 13, the implementation 1300 may include a Transmit Angular login web-based component 130, a PWO IDP jQuery web user interface 131, a PWO landing page or dashboard 132, a Transmit JS SDK 133, at least one Transmit identity journey 134, a Comex Angular web user interface 135, a Comex landing page or dashboard 136, a MicroApp Framework web user interface 137, and an APP landing page or dashboard 138 performing steps 1301-1305, 1311-1315, and/or 1321-1325.

For example, the embodiment 1300 may include setting up a user account of a user (e.g., USR4, as shown in FIG. 11), as described in FIGS. 4, 10, and 12. After the user account of the user (e.g., USR4, as shown in FIG. 11) is set up, the implementation 1300 may include providing at least one web-based user interface (e.g., web-based user interface(s) 1124, as shown in FIG. 11) associated with at least one cloud service (e.g., cloud service(s) 1132, as shown in FIG. 11) provided by a service server (e.g., service server 1130, as shown in FIG. 11). The implementation 1300 may further include steps 1301-1305, 1311-1315, or 1321-1325 for implementing process 1200 in FIG. 12 as described herein.

Step 1301 may implement step 1210. For example, the Transmit Angular login web-based component 130 (e.g., authentication component 1123, as shown in FIG. 11) may be configured to receive a first login request for a personal banking service (e.g., the first one of the cloud service(s) 1132, as shown in FIG. 11) through the PWO IDP jQuery web user interface 131 (e.g., the first one of the web-based user interface(s) 1124, as shown in FIG. 11).

Steps 1302 and 1303 may implement step 1220. For example, in response to receiving the first login request, the Transmit Angular login web-based component 130 (e.g., authentication component 1123, as shown in FIG. 11) may be configured to initiate the Transmit JS SDK 133 (e.g., authentication integration framework 1126, as shown in FIG. 11), to transmit, for example, an authentication option as two-factor authentication to an authentication server (e.g., the authentication server 1110, as shown in FIG. 11), for authenticating the first login request.

Step 1304 may implement step 1230. For example, the Transmit Angular login web-based component 130 (e.g., authentication component 1123, as shown in FIG. 11) may be configured to receive, through an authentication integration framework (e.g., authentication integration framework 1126, as shown in FIG. 11), first token(s) associated with the personal banking service. The Transmit Angular login web-based component 130 (e.g., authentication component 1123, as shown in FIG. 11) may be configured to further display a login success status on the PWO IDP jQuery web user interface 131 (e.g., the first one of the web-based user interface(s) 1124, as shown in FIG. 11).

Step 1305 may implement step 1240. For example, the Transmit Angular login web-based component 130 (e.g., authentication component 1123, as shown in FIG. 11) may be configured to display the PWO landing page or dashboard (e.g., the first one of the landing interface(s) 1125) for the personal banking service.

Step 1311 may implement step 1250. For example, the Transmit Angular login web-based component 130 (e.g., authentication component 1123, as shown in FIG. 11) may be configured to receive a second login request for an investment banking service (e.g., the second one of the cloud service(s) 1132, as shown in FIG. 11) through a Comex Angular web user interface 135 (e.g., the second one of the web-based user interface(s) 1124, as shown in FIG. 11).

Steps 1312 and 1313 may further implement step 1260. For example, in response to receiving the second login request, the Transmit Angular login web-based component 130 (e.g., authentication component 1123, as shown in FIG. 11) may be configured to initiate the Transmit JS SDK 133 (e.g., authentication integration framework 1126, as shown in FIG. 11), to transmit, for example, an authentication option as multi-factor authentication to the authentication server (e.g., the authentication server 1110, as shown in FIG. 11), for authenticating the second login request.

Step 1314 may implement step 1270. For example, the Transmit Angular login web-based component 130 (e.g., authentication component 1123, as shown in FIG. 11) may be configured to receive, through the authentication integration framework (e.g., authentication integration framework 1126, as shown in FIG. 11), second token(s) associated with the investment banking service. The Transmit Angular login web-based component 130 (e.g., authentication component 1123, as shown in FIG. 11) may be configured to further display a login success status on the Comex Angular web user interface 135 (e.g., the second one of the web-based user interface(s) 1124, as shown in FIG. 11).

Step 1315 may implement step 1280. For example, the Transmit Angular login web-based component 130 (e.g., authentication component 1123, as shown in FIG. 11) may be configured to display the Comex landing page or dashboard 136 (e.g., the second one of the landing interface(s) 1125) for the investment banking service.

Step 1321 may also implement step 1250. For example, the Transmit Angular login web-based component 130 (e.g., authentication component 1123, as shown in FIG. 11) may be configured to receive a third login request for a commercial banking service (e.g., the third one of the cloud service(s) 1132, as shown in FIG. 11) through a MicroApp Framework web user interface 137 (e.g., the third one of the web-based user interface(s) 1124, as shown in FIG. 11).

Steps 1322 and 1323 may also further implement step 1260. For example, in response to receiving the third login request, the Transmit Angular login web-based component 130 (e.g., authentication component 1123, as shown in FIG. 11) may be configured to initiate the Transmit JS SDK 133 (e.g., authentication integration framework 1126, as shown in FIG. 11), to transmit, for example, an authentication operation as biometric authentication to the authentication server (e.g., the authentication server 1110, as shown in FIG. 11), for authenticating the third login request.

Step 1324 may also implement step 1270. For example, the Transmit Angular login web-based component 130 (e.g., authentication component 1123, as shown in FIG. 11) may be configured to receive, through the authentication integration framework (e.g., authentication integration framework 1126, as shown in FIG. 11), third token(s) associated with the commercial banking service. The Transmit Angular login web-based component 130 (e.g., authentication component 1123, as shown in FIG. 11) may be configured to further display a login success status on the MicroApp Framework web user interface 137 (e.g., the third one of the web-based user interface(s) 1124, as shown in FIG. 11).

Step 1325 may also implement step 1280. For example, the Transmit Angular login web-based component 130 (e.g., authentication component 1123, as shown in FIG. 11) may be configured to display the APP landing page or dashboard 138 (e.g., the third one of the landing interface(s) 1125) for the commercial banking service.

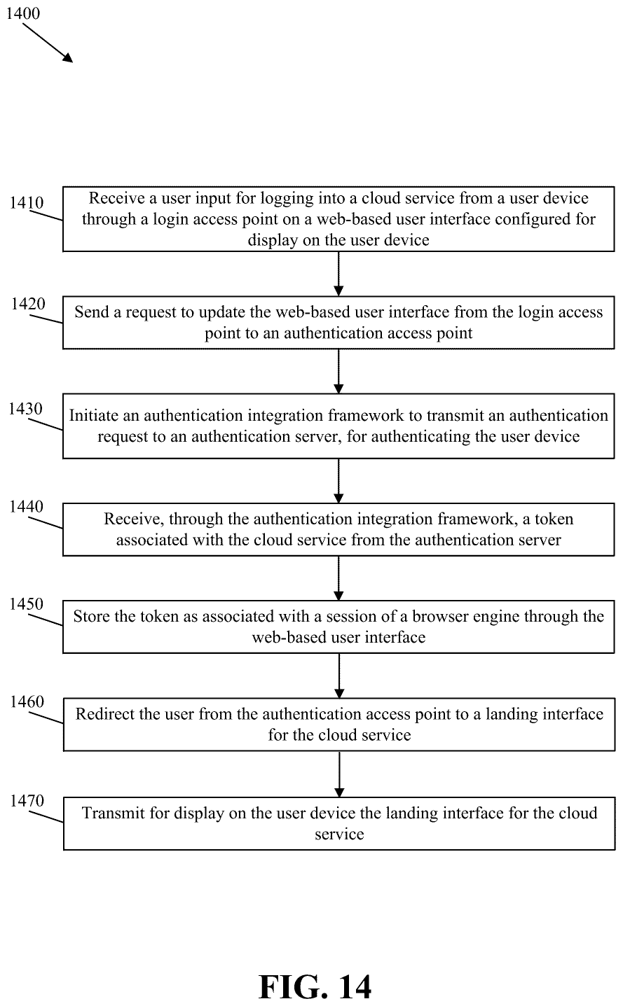

FIG. 14 illustrates a flow chart of an exemplary process 1400 for digital authentication, which may be performed by the exemplary digital authentication system 1100 in FIG. 11, according to some embodiments of the present disclosure. At step 1410, process 1400 may include receiving a user input for logging into a cloud service from a user device through a login access point on a web-based user interface configured for display on the user device. At step 1420, process 1400 may include sending a request to update the web-based user interface from the login access point to an authentication access point. At step 1430, process 1400 may include initiating an authentication integration framework to transmit an authentication request to an authentication server, for authenticating the user device. At step 1440, process 1400 may include receiving, through the authentication integration framework, a token associated with the cloud service from the authentication server. At step 1450, process 1400 may include storing the token as associated with a session of a browser engine through the web-based user interface. At step 1460, process 1400 may include redirecting the user device from the authentication access point to a landing interface for the cloud service. At step 1470, process 1400 may include transmitting for display on the user device the landing interface for the cloud service.

For example, the digital authentication system 1100 (as shown in FIG. 11) may be configured to set up the user account of the user USR4 (as shown in FIG. 11), as described in FIGS. 4, 10, and 12. After the user account of the user USR4 (as shown in FIG. 11) is set up, the digital authentication system 1100 may be configured to provide a first one of the web-based user interface(s) 1124 (as shown in FIG. 11) associated with a first one of the cloud service(s) 1132 (as shown in FIG. 11). The digital authentication system 1100 may be configured to receive, from the user USR4 (as shown in FIG. 11) through the first one of the web-based user interface(s) 1124, a login request for the first one of the cloud service(s) 1132 (as shown in FIG. 11). The login request may include a digital identity of the user USR4 (as shown in FIG. 11). The digital identity of the user USR4 (as shown in FIG. 11) may include a username and a password. The user device 1120 (as shown in FIG. 11) may be configured to transmit the login request to the authentication server 1110 (as shown in FIG. 11) by initiating the authentication component 1123 (as shown in FIG. 11). The authentication component 1123 may be configured to perform steps 1410-1470 of process 1400 and other steps for digital authentication as described herein.

Step 1410 may include receiving a user input for logging into a cloud service (or application) from a user device through a login access point on a web-based user interface configured for display on the user device. For example, the authentication component 1123 (as shown in FIG. 11) may be configured to receive the user input for logging into the first one of the cloud service(s) 1132 (as shown in FIG. 11) from the user USR4 (as shown in FIG. 11) through the login access point (such as, for example, login access points 304, 306, 314, or 720 as shown in FIG. 3 or 7) displayed on the first one of the web-based user interface(s) 1124 (as shown in FIG. 11).

Step 1420 may include sending a request to update the web-based user interface from the login access point to an authentication access point. For example, the authentication component 1123 may be configured to direct the user USR4 (as shown in FIG. 11) from the login access point to an authentication access point (such as, for example, authentication access points 504, 514, or 820 as shown in FIG. 5 or 8) through the first one of the web-based user interface(s) 1124 (as shown in FIG. 11).

Step 1430 may include initiating an authentication integration framework to transmit an authentication request to an authentication server, for authenticating the user device. For example, the authentication component 1123 (as shown in FIG. 11) may be configured to initiate the authentication integration framework 1126 (as shown in FIG. 11) to transmit an authentication request to the authentication server 1110 (as shown in FIG. 11), for authenticating the user device 1120 (as shown in FIG. 11). The authentication server 1110 (as shown in FIG. 11) may be configured to determine whether the user device 1120 (as shown in FIG. 11) is authenticated. In some embodiments, the determination may be performed based on description, examples, and/or embodiments related to step 440 in FIG. 4, or step 650 in FIG. 6. In response to a determination that the user device 1120 (as shown in FIG. 11) is authenticated, the authentication server 1110 (as shown in FIG. 11) may be configured to generate token(s) associated with the first one of the cloud service(s) 1132 (as shown in FIG. 11), and may be configured to transmit, through the authentication integration framework 1112 (as shown in FIG. 11), an authentication response including the token(s) to the authentication component 1123 (as shown in FIG. 11). In some embodiments, the token(s) may be accessing token(s), which may be included in the login or authentication request whenever the user device 1120 (as shown in FIG. 11) is configured to transmit the login or authentication request for logging into the first one of the cloud service(s) 1132 (as shown in FIG. 11).

Step 1440 may include receiving, through the authentication integration framework, a token associated with the cloud service from the authentication server. For example, the authentication component 1123 (as shown in FIG. 11) may be configured to receive, through the authentication integration framework 1126 (as shown in FIG. 11), the token(s) associated with the first one of the cloud service(s) 1132 (as shown in FIG. 11) from the authentication server 1110 (as shown in FIG. 11).

Step 1450 may include storing the token as associated with a session of a browser engine through the web-based user interface. For example, the authentication component 1123 (as shown in FIG. 11) may be configured to store the token(s) as associated with a session of a browser engine through the first one of the web-based user interface(s) 1124 (as shown in FIG. 11).

Step 1460 may include redirecting the user device from the authentication access point to a landing interface for the cloud service. For example, the authentication component 1123 (as shown in FIG. 11) may be configured to redirect the user device 1120 (as shown in FIG. 11) from the authentication access point to the first one of the landing interface 1125 (as shown in FIG. 11) for the first one of the cloud service(s) 1132 (as shown in FIG. 11), e.g., through the first one of the web-based user interface(s) 1124 (as shown in FIG. 11).

Step 1470 may include transmitting for display on the user device the landing interface for the cloud service. For example, the authentication component 1123 may be configured to display the first one of the landing interface 1125 (as shown in FIG. 11) for the first one of the cloud service(s) 1132 (as shown in FIG. 11), e.g., through the first one of the web-based user interface(s) 1124 (as shown in FIG. 11).

In some embodiments, after performing step 1470, the authentication component 1123 (as shown in FIG. 11) may be configured to receive a logout request through the first one of the landing interface 1125 (as shown in FIG. 11) for the first one of the cloud service(s) 1132 (as shown in FIG. 11). The authentication component 1123 (as shown in FIG. 11) may be configured to transmit for display on the user device 1120 (as shown in FIG. 11) the login access point through the first one of the web-based user interface(s) 1124 (as shown in FIG. 11).

In some embodiments, after performing step 1470, the authentication component 1123 (as shown in FIG. 11) may be configured to receive a second user input for the same first one of the cloud service(s) 1132 (as shown in FIG. 11) through the session of the browser engine. The authentication component 1123 (as shown in FIG. 11) may be configured to skip authenticating the user device 1120 (as shown in FIG. 11) according to the token(s) stored in the session of the browser engine, and may be configured to transmit for display on the user device 1120 the landing interface(s) 1125 (as shown in FIG. 11) associated with the authenticated first one of the cloud service(s) 1132 (as shown in FIG. 11), e.g., through the first one of the web-based user interface(s) 1124 (as shown in FIG. 11).

According to process 1400, the authentication component 1123 (as shown in FIG. 11), the authentication integration framework 1126 (as shown in FIG. 11), and the authentication integration framework 1112 (as shown in FIG. 11) can be used as an authentication widget for processing login or authentication requests from the user device 1120 (as shown in FIG. 11). The authentication widget provides a unified login experience with support for multiple authentication methods, ensuring consistency across platforms such as web-based interfaces. The authentication widget also provides a standardized and modular authentication process to simplify integration, reduce development effort, and streamline processes. Thus, a unified login or authentication functionality that enables developers to create a consistent and scalable login or authentication experience across all platforms is provided. On the other hand, the token(s) stored in the session of the browser engine can be used to enable seamless access without requiring repeated authentication of the user device 1120 (as shown in FIG. 11) requesting for the same first one of the cloud service(s) 1132 (as shown in FIG. 11). Thus, a login process that does not rely solely on complex passwords is also provided.

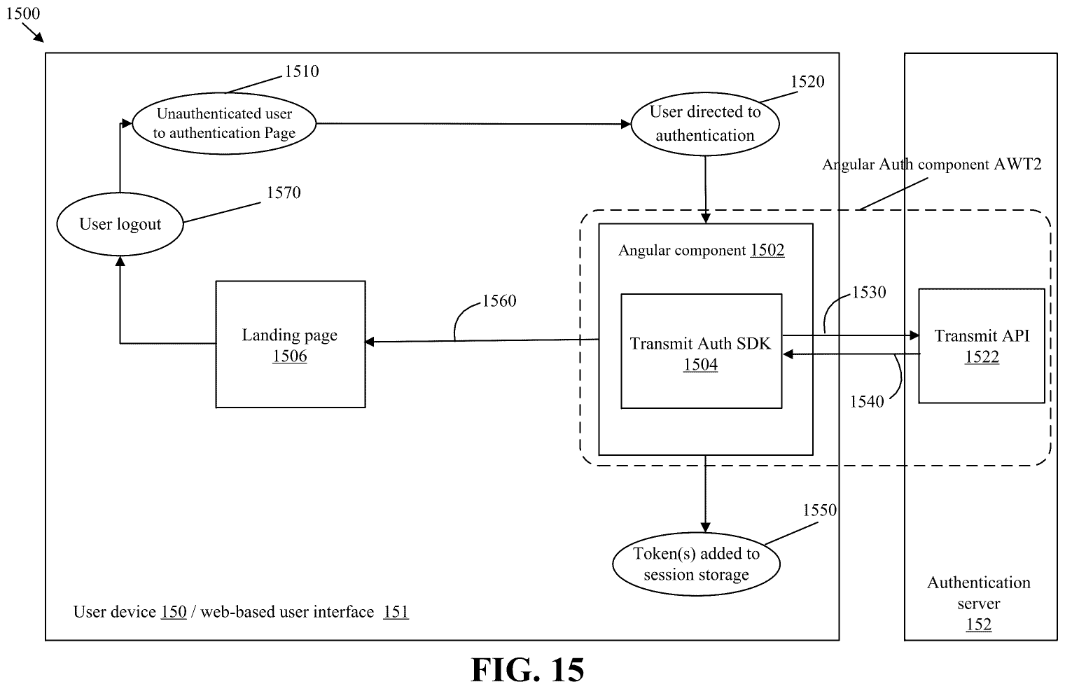

FIG. 15 illustrates an exemplary implementation 1500 of an exemplary process 1400 in FIG. 14 for digital authentication, according to some embodiments of the present disclosure. As shown in FIG. 15, the implementation 1500 may include a user device 150 and an authentication server 152 performing steps 1510-1570. The user device 150 may be configured to generate a web-based user interface 151 and a landing page 1506, and may include an Angular component 1502 and a Transmit Auth SDK 1504. The authentication server 152 may include a Transmit API 1522. The Angular component 1502, the Transmit Auth SDK 1504, and the Transmit API 1522 can be deployed as an Angular Auth component AWT2, for a user (e.g., USR4, as shown in FIG. 11) from the user device 150.

For example, the implementation 1500 may include setting up a user account of a user (e.g., USR4, as shown in FIG. 11), as described in FIGS. 4, 10 and 12. After the user account of the user (e.g., USR4, as shown in FIG. 11) is set up, the implementation 1500 may include providing the web-based user interface 151 (e.g., web-based user interface(s) 1124, as shown in FIG. 11) associated with a cloud service (e.g., cloud service(s) 1132, as shown in FIG. 11) provided by a service server (e.g., service server 1130, as shown in FIG. 11). The implementation 1500 may further include steps 1510-1570 for implementing process 1400 in FIG. 14 as described herein.

Step 1510 may implement step 1410. For example, the Angular component 1502 (e.g., authentication component 1123, as shown in FIG. 11) may be configured to receive a user input for logging into the cloud service (e.g., cloud service(s) 1132, as shown in FIG. 11) from an unauthenticated user (e.g., USR4, as shown in FIG. 11) through a login page displayed on the web-based user interface 151 (e.g., web-based user interface(s) 1124, as shown in FIG. 11).

Step 1520 may implement step 1420. For example, the Angular component 1502 (e.g., authentication component 1123, as shown in FIG. 11) may be configured to direct the unauthenticated user (e.g., USR4, as shown in FIG. 11) from the login page to an authentication page through the web-based user interface 151 (e.g., web-based user interface(s) 1124, as shown in FIG. 11).

Step 1530 may implement step 1430. For example, the Angular component 1502 (e.g., authentication component 1123, as shown in FIG. 11) may be configured to initiate the Transmit Auth SDK 1504 (e.g., authentication integration framework 1126, as shown in FIG. 11) to transmit an authentication request to the Transmit API (e.g., authentication integration framework 1112, as shown in FIG. 11), for authenticating the user device 150 (e.g., user device 1120, as shown in FIG. 11). The Transmit API (e.g., authentication integration framework 1112, as shown in FIG. 11) may be configured to determine whether the user device 150 (e.g., user device 1120, as shown in FIG. 11) is authenticated, and may generate token(s), when the Transmit API (e.g., authentication integration framework 1112, as shown in FIG. 11) successfully authenticate the user (e.g., USR4, as shown in FIG. 11).

Step 1540 may implement step 1440. For example, the Angular component 1502 (e.g., authentication component 1123, as shown in FIG. 11) may be configured to receive, through the Transmit Auth SDK 1504 (e.g., authentication integration framework 1126, as shown in FIG. 11), the token(s) associated with the cloud service (e.g., cloud service(s) 1132, as shown in FIG. 11) from the authentication server 152 (e.g., the authentication server 1110, as shown in FIG. 11).

Step 1550 may implement step 1450. For example, the Angular component 1502 (e.g., authentication component 1123, as shown in FIG. 11) may be configured to store the token(s) as associated with a session of a browser engine through the web-based user interface 151 (e.g., web-based user interface(s) 1124, as shown in FIG. 11).

Step 1560 may implement step 1460. For example, the Angular component 1502 (e.g., authentication component 1123, as shown in FIG. 11) may be configured to redirect the user (e.g., USR4, as shown in FIG. 11) from the authentication page to the landing page 1506 (e.g., the landing interface(s) 1125, as shown in FIG. 11) for the cloud service (e.g., the cloud service(s) 1132, as shown in FIG. 11) through the web-based user interface 151 (e.g., the web-based user interface(s) 1124, as shown in FIG. 11). Thus, the authenticated cloud service (e.g., the cloud service(s) 1132, as shown in FIG. 11) may be configured to recognize the token(s) in the session of the browser engine.

Step 1570 may implement step 1470. For example, the Angular component 1502 (e.g., authentication component 1123, as shown in FIG. 11) may be configured to display the landing page 1506 (e.g., the landing interface(s) 1125, as shown in FIG. 11) for the cloud service (e.g., the cloud service(s) 1132, as shown in FIG. 11) through the web-based user interface 151 (e.g., the web-based user interface(s) 1124, as shown in FIG. 11). The Angular component 1502 (e.g., authentication component 1123, as shown in FIG. 11) may be configured to receive a logout request through the web-based user interface 151 (e.g., the web-based user interface(s) 1124, as shown in FIG. 11), after displaying the landing page 1506 (e.g., the landing interface(s) 1125, as shown in FIG. 11). The Angular component 1502 (e.g., authentication component 1123, as shown in FIG. 11) may be configured to direct the user (e.g., USR4, as shown in FIG. 11) back to the login page displayed on the web-based user interface 151 (e.g., web-based user interface(s) 1124, as shown in FIG. 11).

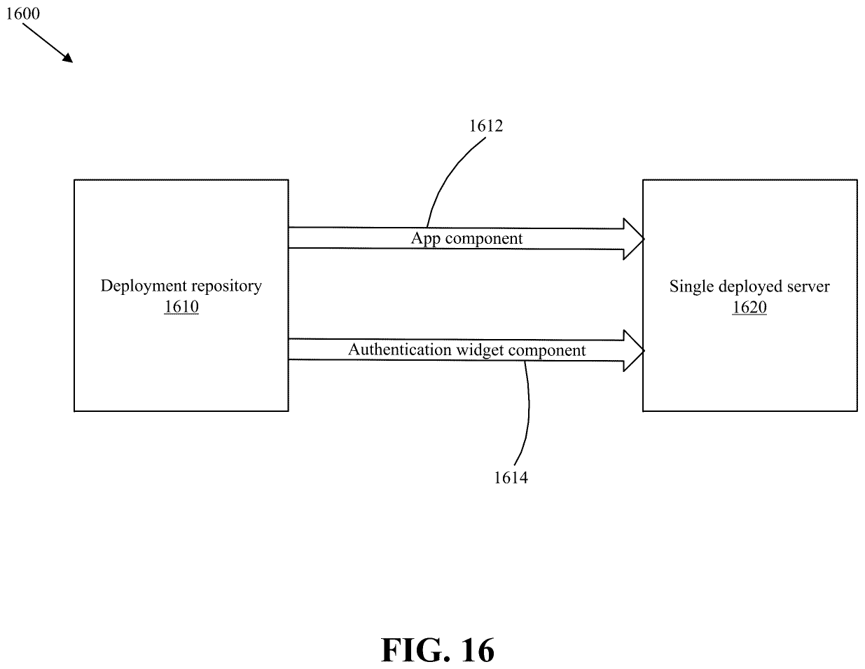

FIG. 16 illustrates a deployment 1600 for the exemplary digital authentication system 1100 in FIG. 11 and the exemplary implementation 1500 in FIG. 15 for digital authentication, according to some embodiments of the present disclosure. The deployment 1600 may include a deployment repository 1610 and a single deployed server 1620 (e.g., user device 1120 or authentication server 1110 as shown in FIG. 11, user device 150 or authentication server 152 as shown in FIG. 15). The deployment repository 1610 may be a version control system, such as Git or GitHub. The deployment repository 1610 may include various versions of the app component 1612 (e.g., authentication component 1123 as shown in FIG. 11, Angular component 1502 as shown in FIG. 15), and related necessary files, configurations, and dependencies for deploying the app component 1612 to the single-deployed server 1620. The deployment repository 1610 may also include various versions of the authentication widget component 1614 (e.g., authentication widget component AWT1 as shown in FIG. 11, or Angular Auth component AWT2 as shown in FIG. 15), and related necessary files, configurations, and dependencies for deploying the authentication widget component 1614 to the single-deployed server 1620.

The deployment 1600 may include deploying the App component and the authentication widget component 1614 to the single deployed server 1620, by using a deployment way, such as File Transfer Protocol (FTP), Secure Shell (SSH) FTP (SFTP), or any third-party deployment service, such as Azure App Service. After successfully deploying the app component 1612 and the authentication widget component 1614 to the single-deployed server 1620, the single-deployed server 1620 may be configured to run or access these components, whereby the single-deployed server 1620 may be configured to perform digital authentication as described in FIGS. 11 and 15.

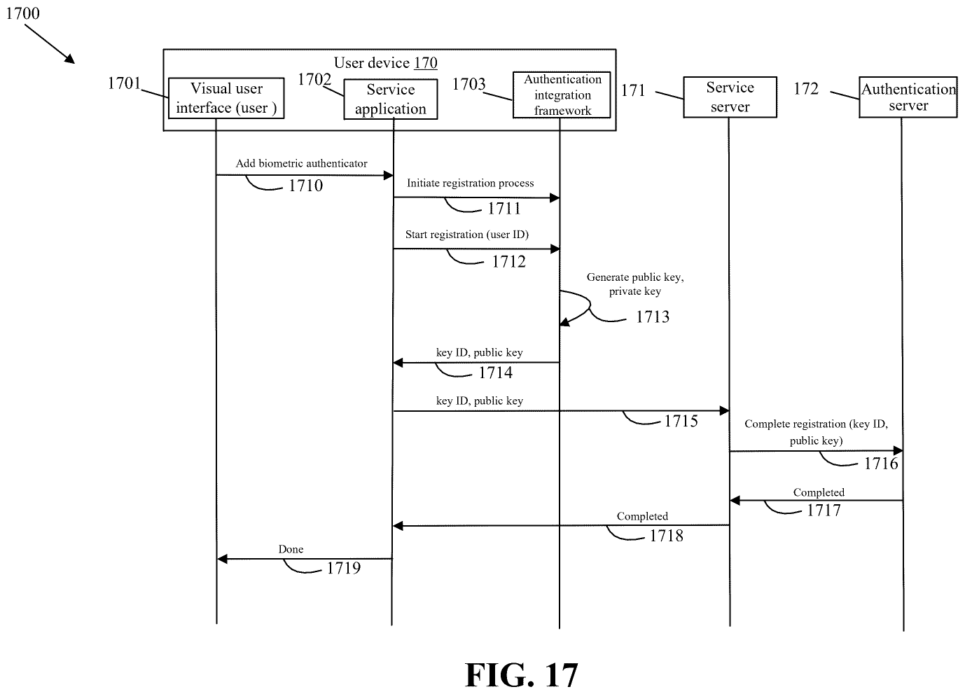

FIG. 17 illustrates an exemplary biometrics registration flow diagram 1700 for digital authentication, which may be performed by the exemplary digital authentication system 1100 in FIG. 11, according to some embodiments of the present disclosure. The steps shown in the biometrics registration flow diagram 1700, which may include steps 1710-1719, may be performed by a user device 170 (e.g., user device 1120, as shown in FIG. 11) associated with a user (e.g., USR4, as shown in FIG. 11), a service server 171 (e.g., service server 1130, as shown in FIG. 11), and an authentication server 172 (e.g., authentication server 1110, as shown in FIG. 11). The user device 170 (e.g., user device 1120, as shown in FIG. 11) may include a visual user interface 1701 (e.g., visual user interface 1122, as shown in FIG. 11), a service application 1702 (e.g., including or launching authentication component 1123, as shown in FIG. 11), and an authentication integration framework 1703 (e.g., authentication integration framework 1126, as shown in FIG. 11).

Step 1710 may include that the service application 1702 receives a registration request for registering a biometric authenticator associated with the user on the user device 170 through the visual user interface 1701. In some embodiments, the biometric authenticator may be detected by biometric sensors of the user device 170. In some embodiments, the biometric authenticator may include at least one of fingerprint data, facial data, iris data, retina data, or voice data.

Step 1711 may include that the service application 1702 initiates the authentication integration framework 1703 to register the biometric authenticator associated with the user on the user device 170. The user may then initiate steps associated with the biometric authentication.

Step 1712 may include that the service application 1702 provides a user identity and/or the biometric authenticator associated with the user to the authentication integration framework 1703, for starting a registering of the biometric authenticator associated with the user on the user device 170.

Step 1713 may include that in response to successfully registering the biometric authenticator associated with the user on the user device 170, the authentication integration framework 1703 generates a public key and a private key according to the biometric authenticator.

Step 1714 may include that the service application 1702 receives the public key and a public key identity of the public key from the authentication integration framework 1703.

Step 1715 may include that the service application 1702 transmits the public key and the public key identity to the service server 171, for the service server 171 to complete the biometrics registration flow by submitting these parameters to the authentication server 172. As described in FIG. 11, the authentication integration framework 1112 may be an authentication API.

Step 1716 may include that the service server 171 transmits a complete registration message to the authentication server 172. The complete registration message includes the public key and the public key identity of the public key.

Step 1717 may include that the service server 171 receives the complete message from the authentication server 172.

Step 1718 may include that the service application 1702 receives the complete message from the service server 171.

Step 1719 may include that the service application 1702 displays that the registration is completed through the visual user interface 1701.

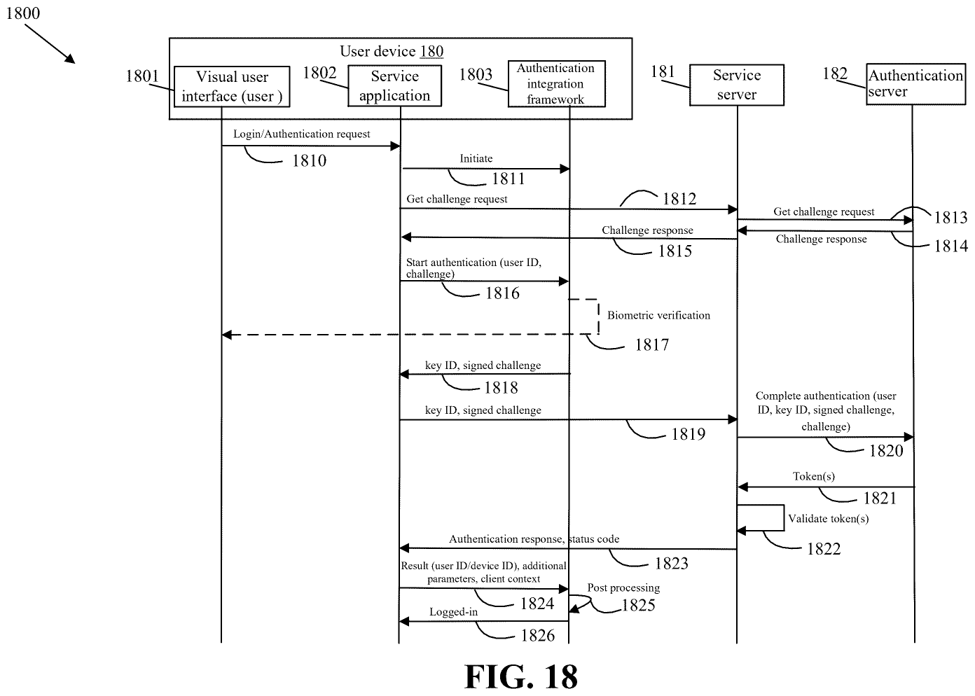

FIG. 18 illustrates an exemplary biometrics authentication flow diagram 1800 for digital authentication, which may be performed by the exemplary digital authentication system 1100 in FIG. 11, according to some embodiments of the present disclosure. The steps shown in the biometrics authentication flow diagram 1800, which may include steps 1810-1826, may be performed by a user device 180 (e.g., user device 170 or 1120, as shown in FIG. 17 or 11) associated with a user (e.g., USR4, as shown in FIG. 11), a service server 181 (e.g., service server 171 or 1130, as shown in FIG. 17 or 11), and an authentication server 182 (e.g., authentication server 172 or 1110 as shown in FIG. 17 or 11). The user device 180 may include a visual user interface 1801 (e.g., visual user interface 1701 or 1122, as shown in FIG. 17 or 11), a service application 1802 (e.g., service application 1702 or including or launching authentication component 1123 as shown in FIG. 17 or 11), and an authentication integration framework 1803 (e.g., authentication integration framework 1703 or 1126, as shown in FIG. 17 or 11).

Step 1810 may include that the service application 1802 receives a login or authentication request for logging in the service application 1802 using a biometric authenticator associated with the user through the visual user interface 1801.

Step 1811 may include that the service application 1802 initiates the authentication integration framework 1803, for checking whether the user device 180 is already bound to the user. If the user device 180 is bound to the user, the service application 1802 may proceed authenticating the biometric authenticator. If the user device 180 is not bound to the user, the service application 1802 may initiate a device binding process.

Step 1812 may include that the service application 1802 transmits a get challenge request to the service server 181.

Step 1813 may include that the service server 181 transmits the get challenge request to the authentication server 182.

Step 1814 may include that the service server 181 receives a challenge response from the authentication server 182, the challenge response includes a challenge parameter.

Step 1815 may include that the service application 1802 receives the challenge response from the service server 181.

Step 1816 may include that the service application 1802 provides the user identity, the challenge parameter, and the biometric authenticator to the authentication integration framework 1803, for starting the authentication integration framework 1803 to authenticate or verify the biometric authenticator.

Step 1817 may include that the authentication integration framework 1803 authenticates or verifies the biometric authenticator using the registered biometric authenticator associated with the user on the user device 180 and signs the challenge parameter using the private key (e.g., generated in step 1713 of the biometrics registration flow diagram 1700) in response to successfully authenticating or verifying the biometric authenticator.

Step 1818 may include that in response to successfully authenticating the biometric authenticator, the service application 1802 receives the public key identity of the public key (e.g., generated in step 1713 of biometrics registration flow diagram 1700) and a signed challenge parameter from the authentication integration framework.

Step 1819 may include that the service application 1802 transmits the public key identity and the signed challenge parameter to the service server 181.

Step 1820 may include that the service server 181 transmits a complete authentication message to the authentication server 182, the complete authentication message may include the user identity, the public key identity of the public key, the signed challenge parameter, and the challenge parameter. The authentication server 182 may be configured to authenticate or verify the signed challenge parameter using the public key. In response to the signed challenge parameter being authenticated or verified, the authentication server 182 may be configured to obtain confirmation that the complete authentication message is received from a correct user device, and may be configured to generate token(s) associated with the service application 1802, and may be configured to transmit the token(s) to the service server 181.

Step 1821 may include that the service server 181 receives the token(s) from the authentication server 182.

Step 1822 may include that the service server 181 validates the token(s).

Step 1823 may include that the service application 1802 receives an authentication response and a status code from the service server 181. The logged-in message may include the token(s). The status code may include information that indicates that the authentication is successful or has failed.

Step 1824 may include that the service application 1802 notifies the authentication integration framework 1803 of a result, for example, including the user identity and/or a user device identity, additional parameters, or user or client context. The additional parameters may include the validated token(s), for example, a session token or an access token. The additional parameters may include a transaction identity, for example, for tracking the authentication request. The additional parameters may include an authentication method, for example, the two-factor authentication, being used to authenticate the user device 190. The additional parameters may further include a configuration for configuring the authentication integration framework 1903.

Step 1825 may include that the authentication integration framework 1803 performs a post processing based on the result.

Step 1826 may include that the service application 1802 receives a logged-in message from the authentication integration framework 1803, the logged-in message may indicate that the authentication is completed.

According to the biometrics registration flow diagram 1700 and biometrics authentication flow diagram 1800, the authentication integration framework 1703 or 1803 may be configured to generate the public key and the private key using the biometric feature(s) and sign the challenge parameter using the private key. The authentication server 182 may be configured to authenticate the signed challenge parameter using the public key. This approach may provide a biometrics-based, password-less, and cryptographically secure (e.g., using asymmetric keys) authentication process that may reduce reliance on managing and memorizing complex passwords. Thus, a login process that does not rely solely on complex passwords is provided.

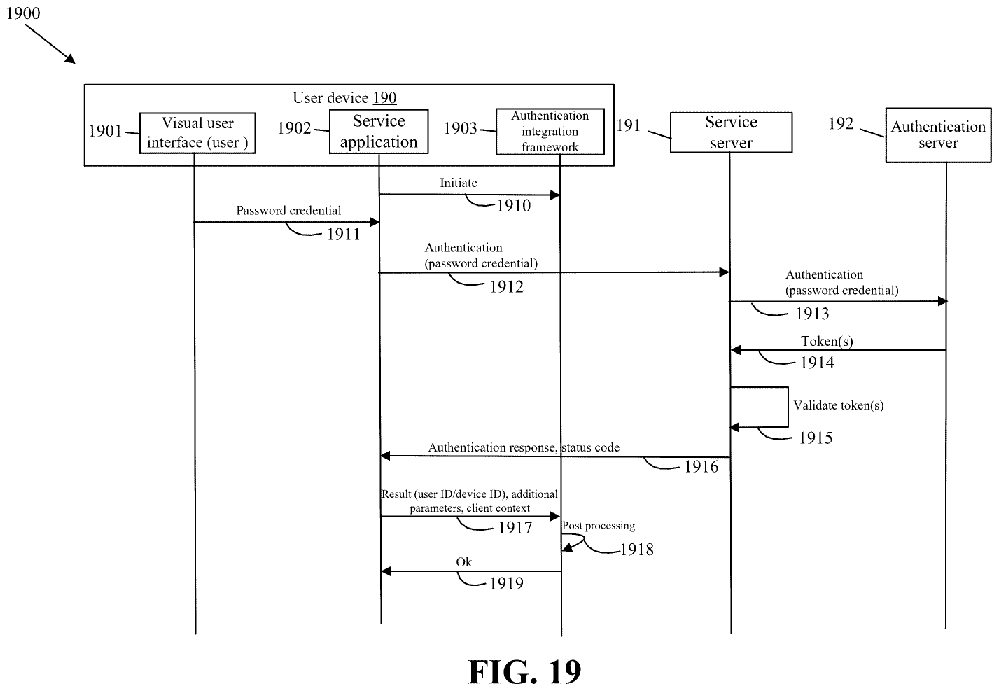

FIG. 19 illustrates an exemplary password authentication flow diagram 1900 for digital authentication, which may be performed by the exemplary digital authentication system 1100 in FIG. 11, according to some embodiments of the present disclosure. The steps shown in the password authentication flow diagram 1900, which may include steps 1910-1919, may be performed by a user device 190 (e.g., user device 1120, as shown in FIG. 11) associated with a user (e.g., USR4, as shown in FIG. 11), a service server 191 (e.g., service server 1130, as shown in FIG. 11), and an authentication server 192 (e.g., authentication server 1110, as shown in FIG. 11). The user device 190 may include a visual user interface 1901 (e.g., visual user interface 1122, as shown in FIG. 11), a service application 1902 (e.g., including or launching authentication component 1123, as shown in FIG. 11), and an authentication integration framework 1903 (e.g., authentication integration framework 1126, as shown in FIG. 11). The service server 191 (e.g., service server 1130, as shown in FIG. 11) may be configured to provide a bank service. The bank service may include at least one of an online and mobile banking service, a personal banking service, or an auto loan service.

Step 1910 may include that the service application 1902 initiates the authentication integration framework 1903, for checking whether the user device 190 is already bound to the user. If the user device 190 is bound to the user, the service application 1902 may proceed step 1911, for example, authenticating a password credential associated with the user device 190. If the user device 190 is not bound to the user, the service application 1902 may initiate a device binding process.

Step 1911 may include that the service application 1902 receives an authentication request through the visual user interface, the authentication request including the password credential associated with the user device 190. The password credential may include a password, or a user identifier, and the user identifier includes at least one of a username, a user email, a user phone number, or a user identity.

Step 1912 may include that the service application 1902 transmits the password credential to the service server 191, for initiating authenticating the user device 190.

Step 1913 may include that the service server 191 transmits the password credential to the authentication server 192. The authentication server 192 may be configured to authenticate the user device 190 by at least one of a single-factor authentication, a two-factor authentication, a multi-factor authentication, a fast-factor authentication, a fast-identity online authentication, or an OTP authentication. The authentication server 192 (e.g., authentication server 1110 as shown in FIG. 11) may be configured to generate the token when the user device is authenticated, and may be configured to transmit the token to the service server 191. In some embodiments, the user device is authenticated or validated when the password credential matches another second password credential stored in a database associated with the authentication server 192. In some embodiments, the token may be a user access token.

Step 1914 may include that the service server 191 receives the token from the authentication server 192.

Step 1915 may include that the service server 191 (e.g., service server 1130 as shown in FIG. 11) may be configured to validate the token(s), and transmits an authentication response and a status code to the service application 1902. The authentication response may include the validated token(s). The status code may include information that indicates that the authentication is successful or has failed.

Step 1916 may include that the service application 1902 receives the authentication response and the status code from the service server 191.

Step 1917 may include that the service application 1902 notifies the authentication integration framework 1903 of a result, for example, including the user identity and/or a user device identity, additional parameters, or user or client context. The additional parameters may include the validated token(s), for example, a session token or an access token. The additional parameters may include a transaction identity, for example, for tracking the authentication request. The additional parameters may include an authentication method, for example, the two-factor authentication, being used to authenticate the user device 190. The additional parameters may further include a configuration for configuring the authentication integration framework 1903.

Step 1918 may include that the authentication integration framework 1903 performs a post processing based on the result.

Step 1919 may include that the service application 1902 receives a confirmed, for example, “OK”, message from authentication integration framework 1903, the confirmed message may indicate that the authentication is completed.

According to the password authentication flow diagram 1900, after the authentication server 192 successfully authenticates the user device 190 using the password credential, the authentication server 192 may be configured to return the validated token(s). The validated token(s) may be included in subsequent login or authentication requests to identify the user device 190 as already authenticated. This approach may allow the user device 190 to not need to repeatedly submit password credentials in each login request, thereby reducing reliance on managing and memorizing complex passwords.

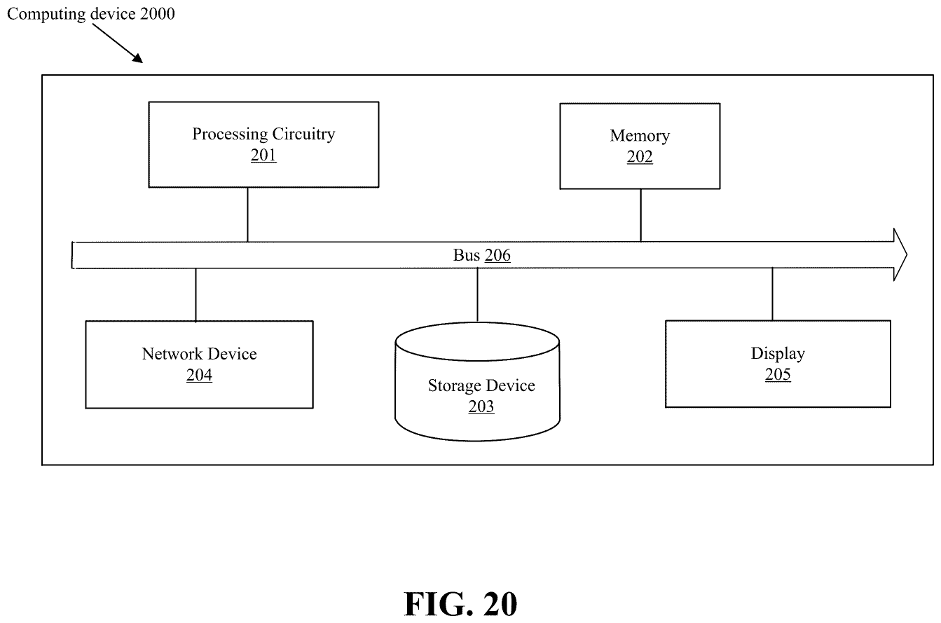

FIG. 20 illustrates a block diagram of an exemplary computing device 2000 in digital authentication systems 300, 500, 900, 1100, or 1700-1900 in FIG. 3, 5, 9, 11, or 17-19, respectively, according to some embodiments of the present disclosure. For example, the computing device 2000 may be any of the user devices 30, 31, 50, 51, 90, 91, 1120, 150, 170, 180, or 190; the authentication server 320, 520, 930, 1110, 1510, 172, 182, or 192; the recording server 332, or 532, the database 334, or 534; the service provider 340; the service server 1130, 171, 181, or 191; the identity checking server 920; the external server 950; the service access point 940; or the single deployed server 1620. As shown in FIG. 20, the computing device 2000 may include a processing circuitry 201, a memory 202, a storage device 203, a network device 204, a display 205, and a bus 206. The processing circuitry 201, the memory 202, the storage device 203, the network device 204, and the display 205 may be coupled with each other through the bus 206.

The processing circuitry 201, for example, may include a central processing unit (CPU). The CPU may be a hardware component responsible for executing instructions of a computer program. The CPU may be configured to perform arithmetic and logic operations, manage data storage and retrieval, and control input and output devices. In some embodiments, the processing circuitry 201 may include, or may be a component of, a larger processing unit implemented with one or more processors. The one or more processors may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, and/or any other suitable entities that can perform calculations or other manipulations of information. The microprocessor may be designed for general-purpose computing tasks. The microcontroller may be a compact integrated circuit containing a processor core, memory, and input/output peripherals, which may be used for embedded systems and specific control applications. The DSP may be designed for executing digital signal processing tasks, such as image processing, audio processing, video processing, modulating, and demodulating digital signals in a mobile network, biomedical signal processing, and/or digital signal analysis. The FPGA may be a programmable integrated circuit (IC) configured to be programmed after manufacturing. The FPGA may be a customizable digital logic circuit configured to perform specific tasks or functions. The FPGA may be reconfigurable for a wide range of applications.

The memory 202 may include a memory portion that may be configured to store instructions that when executed by the processing circuitry 201, may be configured to perform the methods described in more detail herein. The memory 202 may be further used as a working scratch pad for processing circuitry 201, a temporary storage, and others. The memory 202 may be a volatile memory, which may include but is not limited to, random access memory (RAM), and/or non-volatile memory (NVM), which may include but is not limited to, a flash memory.

The processing circuitry 201 and/or the memory 202 may also include machine readable media for storing software. “Software,” as used herein, refers broadly to any type of instructions, whether referred to as software, firmware, middleware, microcode, hardware description language, or otherwise. Instructions may include code (e.g., in source code format, binary code format, executable code format, or any other suitable format of code). The steps in the processes 400, 600, 1000, 1200, or 1400, implementations 1300 or 1500, or flows 1700-1900 may be compiled into program code. The instructions, when executed by the processing circuitry 201, are configured to cause the processing circuitry 201 to execute various functions.

The storage device 203 may be used for storing single data type column-oriented data structures, data elements associated with the data structures, or any other data structures. The storage device 203 may be a generic or specific electronic device capable of storing codes and data accessible by the processing circuitry 201 (e.g., through the bus 206). For example, the storage device 203 may include any combination of any number of a RAM, a read-only memory (ROM), an optical disc, a magnetic disk, a hard drive, a solid-state drive, a flash drive, a secure digital (SD) card, a memory stick, a compact flash (CF) card, or any type of storage device. The codes and data may include an operating system (OS) and one or more application programs (or “apps”) for specific tasks. While illustrated in FIG. 20 as a single device, it is to be understood that storage device 203 may include multiple devices, either collocated or distributed. The storage device 203 may also be a virtual memory that includes one or more storage devices distributed across multiple machines or devices coupled via a network.

The network device 204 may be a network interface card (NIC), for providing connectivity between the computing device 2000 and a network. The NIC may be a hardware component that enables a computer or other device to connect to a network, providing a physical interface for the transmission and reception of data over the network. The display 205 may be a computer screen, a phone screen, a tablet screen, or any other structure capable of displaying data. The display 205 may include a visual user interface that may be configured to enable users to input information, enter the information, or obtain information from the computing device 2000 in the digital authentication systems 300, 500, 900, and/or 1100. Additionally, a visual user interface driver may be configured to generate the visual user interface on the display 205 that may be configured to facilitate interaction and data exchange between the users and the computing device 2000 in the digital authentication systems 300, 500, 900, and/or 1100. The bus 206 may be configured as a communication pathway or a set of conductors that may enable multiple components or devices to exchange data and signals within the circuit.

The term of “access point” may refer to a “portal,” which may serve as an entry or interface for users, user devices or systems to access specific resources, services, or networks. In some embodiments, “access point” and “portal” are interchangeable, facilitating interaction with designated features or environments. The operation of “determining” may refer to “obtaining,” “calculating” or “computing,” which are operations performed by a computing device. In some embodiments, the operation of “determining” may be used interchangeably with “obtaining,” “calculating,” or “computing.”

The “authenticating a user device” may be referred to “verifying or authenticating a user device associated with a user.”

The disclosed embodiments are not limited to the above-described examples, but instead are defined by the appended claims in light of their full scope of equivalents. Moreover, while illustrative embodiments have been described herein, the scope includes any and all embodiments having equivalent elements, modifications, omissions, combinations (e.g., of aspects across various embodiments), adaptations, or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps or inserting or deleting steps.

It is intended, therefore, that the specification and examples be considered as examples only, with a true scope and spirit being indicated by the following claims and their full scope of equivalents.

1-110. (canceled)

111. A method for performing digital authentication, the method comprising:
receiving a registration request for registering a biometric authenticator associated with a user on a user device through a visual user interface;
providing a user identity and the biometric authenticator associated with the user to an authentication integration framework for starting a registration of the biometric authenticator associated with the user on the user device;
in response to successfully registering the biometric authenticator associated with the user on the user device, receiving a public key and a public key identity from the authentication integration framework;
transmitting the public key and the public key identity to an authentication server through a service server;
receiving a complete message from the authentication server through the service server, the complete message indicating that the registration is completed; and
displaying that the registration is completed through the visual user interface.

112. The method of claim 111, wherein the biometric authenticator is detected by the user device.

113. The method of claim 111, wherein the biometric authenticator includes at least one of fingerprint data, facial data, iris data, retina data, or voice data.

114. The method of claim 111, wherein the public key and a private key are generated according to the biometric authenticator in response to successfully registering the biometric authenticator.

115. The method of claim 111, wherein the biometric authenticator is a first biometric authenticator; and the method further comprises:
receiving a login request for logging in a service application using a second biometric authenticator associated with the user through the visual user interface;
providing the user identity, a challenge parameter, and the second biometric authenticator to the authentication integration framework, for starting authenticating the second biometric authenticator;
in response to successfully authenticating the second biometric authenticator, receiving the public key identity and a signed challenge parameter from the authentication integration framework;
transmitting the public key identity and the signed challenge parameter to the authentication server through the service server;
receiving a logged-in message from the service server, the logged-in message indicating that the authentication is completed; and
displaying that the authentication is completed through the visual user interface.

116. The method of claim 115, wherein the challenge parameter is signed using a private key, the private key being generated in response to successfully registering the biometric authenticator associated with the user on the user device.

117. The method of claim 115, wherein the second biometric authenticator includes at least one of fingerprint data, facial data, iris data, retina data, or voice data.

118. The method of claim 115, wherein the logged-in message includes a token, the token being generated when the signed challenge parameter is verified by the authentication server using the public key.

119. A system for performing digital authentication, the system comprising:
a memory storing a set of instructions; and
a processor configured to execute the stored instructions to perform operations including:
receive a registration request for registering a biometric authenticator associated with a user on a user device through a visual user interface;
provide a user identity and the biometric authenticator associated with the user to an authentication integration framework for starting a registration of the biometric authenticator associated with the user on the user device;
in response to successfully registering the biometric authenticator associated with the user on the user device, receive a public key and a public key identity from the authentication integration framework;
transmit the public key and the public key identity to an authentication server through a service server;
receive a complete message from the authentication server through the service server, the complete message indicating that the registration is completed; and
display that the registration is completed through the visual user interface.

120. The system of claim 119, wherein the biometric authenticator is detected by the user device.

121. The system of claim 119, wherein the biometric authenticator includes at least one of fingerprint data, facial data, iris data, retina data, or voice data.

122. The system of claim 119, wherein the public key and a private key are generated according to the biometric authenticator in response to successfully registering the biometric authenticator.

123. The system of claim 119, wherein the biometric authenticator is a first biometric authenticator; and the operations further include:
receive a login request for logging in a service application using a second biometric authenticator associated with the user through the visual user interface;
provide the user identity, a challenge parameter, and the second biometric authenticator to the authentication integration framework for initiating authenticating the second biometric authenticator;
in response to successfully authenticating the second biometric authenticator, receive the public key identity and a signed challenge parameter from the authentication integration framework;
transmit the public key identity and the signed challenge parameter to the authentication server through the service server;
receive a logged-in message from the service server, the logged-in message indicating that the authentication is completed; and
display that the authentication is completed through the visual user interface.

124. The system of claim 123, wherein the challenge parameter is signed using a private key, the private key being generated in response to successfully registering the biometric authenticator associated with the user on the user device.

125. The system of claim 124, wherein the signed challenge parameter is verified by the authentication server using the public key.

126. The system of claim 125, wherein a token is generated by the authentication server in response to verifying the signed challenge parameter.

127. The system of claim 126, wherein the logged-in message includes the token.

128. A method for performing digital authentication, the method comprising:
receiving an authentication request through a visual user interface, the authentication request including a password credential associated with a user device;
transmitting the password credential to a service server for initiating an authentication of the user device;
receiving an authentication response from the service server, the authentication response including a token validated by the service server; and
transmitting an authentication result to an authentication integration framework, the authentication result including a user identifier, a user device identifier, or the validated token, for associating the validated token with the user identifier or the user device identifier.

129. The method of claim 128, wherein the user identifier is a first user identifier, the first user identifier including at least one of a username, a user email, a user phone number, or a system-generated identifier; and the password credential includes at least one of a second user identifier or a password, the second user identifier including at least one of the username, the user email, or the user phone number.

130. The method of claim 128, wherein the token is generated when the user device is authenticated.

131. The method of claim 128, wherein the password credential is a first password credential, and the user device is authenticated when the first password credential matches a second password credential stored in a database associated with an authentication server.

132. The method of claim 128, wherein the authentication of the user device includes at least one of a single-factor authentication, a two-factor authentication, a multi-factor authentication, a fast-factor authentication, a fast-identity online authentication, or a one-time password authentication.

133. The method of claim 128, wherein the service server provides a bank service.

134. The method of claim 133 wherein the bank service includes at least one of an online and mobile banking service, a personal banking service, or an auto loan service.

135. A system for performing digital authentication, the system comprising:
a memory storing a set of instructions; and
a processor configured to execute the stored instructions to perform operations including:
receive an authentication request through a visual user interface, the authentication request including a password credential associated with a user device;
transmit the password credential to a service server for initiating authenticating the user device;
receive an authentication response from the service server, the authentication response including a token validated by the service server; and
transmit an authentication result to an authentication integration framework, the authentication result including a user identifier, a user device identifier, or the validated token, for associating the validated token with the user identifier or the user device identifier.

136. The system of claim 135, wherein the user identifier is a first user identifier, the first user identifier including at least one of a username, a user email, a user phone number, or a system-generated identifier; and the password credential includes at least one of a second user identifier or a password, the second user identifier including at least one of the username, the user email, or the user phone number.

137. The system of claim 135, wherein the token is generated when the user device is authenticated.

138. The system of claim 135, wherein the password credential is a first password credential,
and the user device is determined authenticated when the first password credential matches a second password credential stored in a database.

139. The system of claim 135, wherein the authentication of the user device includes at least one of a single-factor authentication, a two-factor authentication, a multi-factor authentication, a fast-factor authentication, a fast-identity online authentication, or a one-time password authentication.

140. The system of claim 135, wherein the service server provides a bank service.

141. The system of claim 140, wherein the bank service includes at least one of an online and mobile banking service, a personal banking service, or an auto loan service.
